(19) United States
(12) Patent Application Publication
(10) Pub. No.: US 2004/0068583 A1
(43) Pub. Date: Apr. 8, 2004

(54) Enhanced apparatus and method for collecting, distributing and archiving high resolution images

(76) Inventors: David A. Monroe, San Antonio, TX (US); Raymond R. Metzger, San Antonio, TX (US)

Correspondence Address: Robert C. Curfiss, Jackson Walker L.L.P., Suite 2100, 112 E. Pecan, San Antonio, TX, 78205, US

(21) Appl. No.: 10/266,813

(22) Filed: Oct. 8, 2002

(51) Int. Cl. G06F 15/16

(52) U.S. Cl. 709/246

(57) ABSTRACT

An image collection, distribution and management system employs wherein multiple compression at the source, permitting various signals to be distributed via a network, depending on the functional aspects of the signal, as well as on the bandwidth capacity of the chosen distribution path or network. Enhanced decompression schemes in the receiving systems further improve the overall efficiency and quality of the transmitted signals. Time stamps are appended to each discrete file to facilitate reproduction of the individual files in the sequence. Further, when transmission of the file through typical communications networks involves significant and variable delay in transmission, the time stamps provide a means for the reproducing device to display each individual file in correct temporal sequence. The time stamp represents the time at which the file was captured, as measured by a suitable time base inside the source. This time base may be provided by the source operating system. Alternatively, the time stamp may be derived from a running count of the incoming frames from the source. The system also supports communications networks having widely differing, non-interoperable protocols. This expands the utility of these disparate networks as media for conveying compressed file sequences.

### BACKGROUND OF THE INVENTION

1. Field of the Invention

The subject invention is directed to a method for collecting, distributing and archiving both variable resolution video and high resolution still images over a network and is specifically directed to a for capturing, transmitting and managing such images using IP protocols while preserving bandwidth.

2. Discussion of the Prior Art

The previous patents and applications of David A. Monroe and David A. Monroe, et al, are incorporated by reference herein as follows:

Ser. No. 08/738,487 Filing Date: Oct. 28, 1996

U.S. Pat. No. 5,798,458 Issue Date: Aug. 25, 1998

Title: Acoustic Catastrophic Event Detection and Data Capture and Retrieval System for Aircraft

Ser. No. 08/745,536 Filing Date: Nov. 12, 1996

U.S. Pat. No. 6,009,356 Issue Date: Dec. 28, 1999

Title: Wireless Transducer Data Capture and Retrieval System for Aircraft

Ser. No. 08/815,026 Filing Date: Mar. 14, 1997

U.S. Pat. No. 5,943,140 Issue Date: Aug. 24, 1999

Title: Method and Apparatus for Sending and Receiving Facsimile Transmissions Over a Non-Telephonic Transmission System

Ser. No. 09/005,931 Filing Date: Jan 12, 1998

Title: Apparatus and Method for Selection of Circuit in Multi-Circuit Communications Device

Ser. No. 09/143,232 Filing Date: Aug. 28, 1998

Title: Multifunctional Remote Control System for Audio Recording, Capture, Transmission and Playback of Full Motion and Still Images

Ser. No. 09/257,448 Filing Date: Feb. 25, 1999

Title: Multi-Casting Communication Protocols for Simultaneous Transmission to Multiple Stations

Ser. No. 09/257,720 Filing Date: Feb. 25, 1999

U.S. Pat. No. 6,392,692 Issue Date: May 21, 2002

Title: Network Communication Techniques for Security Surveillance and Safety System

Ser. No. 09/257,765 Filing Date: Feb. 25, 1999

U.S. Pat. No. 6,366,311 Issue Date: Apr. 02, 2002

Title: Record and Playback System for Aircraft

Ser. No. 09/257,767 Filing Date: Feb. 25, 1999

U.S. Pat. No. 6,246,320 Issue Date: Jun. 12, 2001

Title: Ground Link With On-Board Security Surveillance System for Aircraft and Other Commercial Vehicles

Ser. No. 09/257/769 Filing Date: Feb. 25, 1999

Title: Ground Based Security Surveillance System for Aircraft and Other Commercial Vehicles

Ser. No. 09/257,802 Filing Date: Feb. 25, 1999

U.S. Pat. No. 6,253,064 Issue Date: Jun. 26, 2001

Title: Terminal Based Traffic Management and Security Surveillance System for Aircraft and Other Commercial Vehicles

Ser. No. 09/350,197 Filing Date: Jul. 08, 1999

Title: Apparatus and Method for Selection of Circuit in Multi-Circuit Communications Device

Ser. No. 09/593,901 Filing Date: Jun. 14, 2000

Title: Dual Mode Camera

Ser. No. 09/594,041 Filing Date: Jun. 14, 2000

Title: Multimedia Surveillance and Monitoring System Including Network Configuration

Ser. No. 09/687,713 Filing Date: Oct. 13, 2000

Title: Apparatus and Method of Collecting and Distributing Event Data to Strategic Security Personnel and Response Vehicles

Ser. No. 09/966,130 Filing Date: Sep. 21, 2001

Title: Multimedia Network Appliances for Security and Surveillance Applications

Ser. No. 09/974,337 Filing Date: Oct. 10, 2001

Title: Networked Personal Security System

Ser. No. 09/715,783 Filing Date: Nov. 17, 2000

Title: Multiple Video Display Configurations and Bandwidth Conservation Scheme for Transmitting Video Over a Network

Ser. No. 09/716,141 Filing Date: Nov. 17, 2000

Title: Method and Apparatus for Distributing Digitized Streaming Video Over a Network

Ser. No. 09/725,368 Filing Date: Nov. 29, 2000

Title: Multiple Video Display Configurations and Remote Control of Multiple Video Signals Transmitted to a Monitoring Station Over a Network

Ser. No. 09/853,274 Filing Date: May 11, 2001

Title: Method and Apparatus for Collecting, Sending, Archiving and Retrieving Motion Video and Still Images and Notification of Detected Events

Ser. No. 09/854,033 Filing Date: May 11, 2001

Title: Portable, Wireless Monitoring and Control Station for Use in Connection With a Multi-Media Surveillance System Having Enhanced Notification Functions

Ser. No. 09/866,984 Filing Date: May 29, 2001

Title: Modular Sensor Array

Ser. No. 09/960,126 Filing Date: Sep. 21, 2001

Title: Method and Apparatus for Interconnectivity Between Legacy Security Systems and Networked Multimedia Security Surveillance System

Ser. No. 10/134,413 Filing Date: Apr. 29, 2002

Title: Method for Accessing and Controlling a Remote Camera in a Networked System With Multiple User Support Capability and Integration to Other Sensor Systems

Ser. No. 10/192,870 Filing Date: Jul. 10, 2002

Title: Comprehensive Multi-Media Surveillance and Response System for Aircraft, Operation Centers, Airports and Other Commercial Transports, Centers and Terminals.

In these applications, a system is described containing a plurality of video cameras disposed on a common network. Typically, a number of cameras are disposed around a location or zone to be monitored. Each camera produces a video signal of the scene of interest. The video signal is digitized by a digitizer, compressed and transmitted to a network for distribution to remote receiving stations including a computer supported monitoring station and/or an archival server. The signal is decoded at the computer and server systems and displayed, distributed and archived.

The network may be a simple local-area-network (LAN), providing sufficient capacity for a plurality of cameras which simultaneously produce compressed video signals. Typical LAN's have a capacity of 100 Mbps, sufficient capacity for dozens of such cameras. These LAN's operate over limited distances, however. Local and distant LAN's may be interconnected via a variety of communications pathways, with such interconnections typically offering limited bandwidth. The Internet is a typical example. Internet users typically connect to their local network at a connection speed of 100 Mbps, but the gateway paths to the internet backbone may be 1.5 Mbps or less. Long-haul interconnect paths may be even slower, such as the familiar ISDN network which supports two communications channels of only 64 kbps. This presents a problem when using such a network arrangement for distribution of surveillance video. Users monitoring the various cameras on the local network have access to the high-bandwidth, full-motion video produced by the several cameras. Users outside the local network, however, are often severely limited in available bandwidth, and may be capable of receiving one (or possibly none) such camera video signals.

In the previously incorporated patent applications, cameras simultaneously produce video at several different bitrates, reducing the problem created by the limited-bandwidth LAN interconnects. Depending on the bandwidth of the network interconnects, distant viewers may be able to receive reduced-resolution motion-video signals. For example, a user who enjoys an inter-network bandwidth of 1.5 Mbps may be able to receive one or more low-resolution compressed video signals, each of which may have a bandwidth of 100 kbps and upwards. A different user, however, who is using ISDN as an inter-network pathway will probably not be able to receive any such low-resolution compressed-video signals.

One solution to this problem is to provide a processing resource on the camera's local network, which converts the desired high bit rate video signal into a similar video signal with a lower bit rate, and which then forwards the bit-rate-reduced signal to a user via the low-bandwidth communications channel. While effective, this approach requires a significant amount of processing power, since the high-bitrate compressed video signal must be fully decoded, and re-encoded. In addition, this approach adds additional delay to the video path.

Another approach is to provide a camera/encoder which accepts a selected video signal from a camera, and which subsequently produces one or more compressed motion video signals and one or more compressed still image signals. The still-frame images possess a high resolution, a useful feature for image archival. However, these images typically occur at a low frame rate, due to the amount of time required to capture, digitize, and compress each individual image, and the amount of data required to define that frame. The maximum frame rate is additionally limited by the available bandwidth in the associated communications channel. For example: a source image of 704×480 pixel resolution is compressed using the JPEG algorithm. With typical JPEG compression parameters, this 704×480 image may be represented by an output file of perhaps 50 kilobytes. If it were possible to produce 30 frames/second of this image, the resulting bit rate would be equal to 50 kilobytes×8 bits/byte×30 frames/second, or approximately 12 million bits per second. This is far too fast for typical communications networks or LAN's, particularly if a complement of tens or hundreds of cameras are desired. As a result, this series of still images is typically captured and transmitted at a much lower frame rate, such as one to two frames per second. At such frame rates, the representation of motion is poor.

Motion images, meanwhile, are typically represented in SIF format, which has a source resolution of 352×240 pixels. This is generally done by decimating-by-two the source image in both the horizontal and vertical directions. As a result, the image's source data is reduced by a factor of four prior to compression. In addition, the compression algorithms used for motion video such as the popular MPEG algorithm employ temporal compression, which is not possible with discrete still images. With temporal compression, most frames are represented not as a fully compressed image, but as a ‘difference frame’, wherein the output data represents the minor differences between the frame and it's neighbors. Only every Nth frame is fully encoded as a complete frame. This results in a dramatic reduction in the amount of data required to represent the video sequence. Using temporal compression, MPEG compression may produce image bit rates ranging from a high of perhaps 2 to 5 million bits/second, to a low of perhaps 64 kilobits per second when using QSIF (176×112 pixels) source images and when using aggressive compression.

The previously incorporated patent applications describe a camera which simultaneously produces one or more compressed motion-video data streams, which are then conveyed via a network to one or more monitoring stations. In the prior applications, a series of high-resolution compressed still-frame images is also produced, for the primary purpose of archiving high-resolution compressed still-frame images. In the preferred embodiment, the images were compressed using the JPEG algorithm. In the present invention, these still-frame images are used for a different purpose—to provide a very-low bandwidth alternative to motion video data streams, for those situations where a low-bandwidth communications channel is being used.

The file size of a compressed image is not readily predictable, and is highly dependent on the scene content of the image being compressed. As the scene content changes, the resulting compressed file size changes. This presents a serious problem when attempting to convey a sequence of such images over a constant-bandwidth communications medium.

As the image files are transmitted across the constant-bandwidth communications channel, it is necessary to keep the average image bit rate less than that of the communications channel. If the average image bitrate exceeds the capacity of the communications channel, the received images will ‘lag’ progressively, until the transmitter's buffer overflows. If the average bitrate is less than the capacity of the communications channel but the instantaneous bitrate is bursty (such as when highly-detailed objects pass through an otherwise static scene), then the actual delivery time of the image file to the monitoring station will be variable. The resulting still image file sequence may appear choppy when displayed. This problem may be overcome by adding some image buffering in the receiver, but this adds additional delay to the signal path.

A typical solution to this problem is to capture and compress the source images at some pre-defined frame rate, while monitoring the level of a transmit buffer. If the transmit buffer begins to fill excessively, individual compressed frames may be discarded as necessary to maintain the desired channel data rate. While this approach does successfully guarantee that the channel's capacity is never exceeded, it does so at the expense of dropped frames. This is undesirable. It is visually annoying, and during post-event analysis the dropped frames may have contained valuable visual information.

Therefore, there remains a need for enhancing the collection, distribution and management of high resolution images while conserving bandwidth to permit wide application of the technology.

### SUMMARY OF THE INVENTION

The subject invention is directed to an image collection, distribution and management system wherein multiple compression schemes may be employed at the camera, permitting various signals to be distributed via the network, depending on the functional aspects of the image, as well as on the bandwidth capacity of the chosen distribution path or network. Enhanced decompression schemes in the receiving systems further improve the overall efficiency and quality of the transmitted signals.

In the disclosed invention, cameras use the popular Ethernet networking protocol. Using the familiar OSI hierarchy, Ethernet is used for the physical layer, and UDP/IP is used for the network and transport layers. Networks may be wire, fiber or wireless. Other network protocols and topologies may also be utilized.

The previously incorporated patent applications describe a camera which simultaneously produces one or more compressed motion-video data streams, which are then conveyed via a network to one or more monitoring stations. In the prior applications, a series of high-resolution compressed still-frame images is also produced, for the primary purpose of archiving high-resolution compressed still-frame images. In the preferred embodiment, the images were compressed using the JPEG algorithm. In the present invention, these still-frame images are used for a different purpose—to provide a very-low bandwidth alternative to motion video data streams, for those situations where a low-bandwidth communications channel is being used.

In the invention, generation of the low-bitrate video images is moved into the camera, and these low-bitrate video image sequences are created simultaneously with the high-bitrate video signals. The low-bitrate video signals may then be transported through and between networks, using commonplace low-bandwidth communications channels. Using the invention, remote cameras, or remote monitors, may operate over low-bitrate communications channels or terminals including:

ISDN telephone lines. Typical capacity is 128 kbps.

Frame Relay circuits.

Dial-up modem circuits. Typical capacity is 56 kbps.

Government or military tactical radios, typically 16 kbps.

Public Service Radios

Commercial Radio (Business, Trunking, and the like)

Cellular phones

Blue-Tooth wireless LAN's

IP-Network telephones, with graphic displays

Networked handheld devices such as Personal Digital Assistants (PDA's)

PDA's equipped with embedded cameras

Wrist monitors or cameras

Heads-up monitors, or head-mounted cameras

Monitors integrated into vehicles, such as the General Motors On-Star™ system

Other embedded cameras, such as are used in Shipping Monitoring, Process Control monitoring, Animal Monitoring, Vehicle monitoring, Child monitoring, Employee monitoring, Sports monitoring, Asset monitoring, Transportation monitoring, Elevator monitoring, and the like.

In the invention, incoming video is captured at a high resolution (704×480), and decimated-by-two to yield a SIF resolution (352×240) source image resolution. The image may alternatively be decimated-by-four to yield a QSIF source resolution. In either case, individual, complete frames are then compressed, using a still-image compression algorithm such as JPEG. With a dedicated ASIC to perform the compression, each individual image may be compressed in less than 100 milliseconds (this includes the time required for a complete frame of composite video to be delivered to the ASIC). A time stamp is then added to each image file. Finally, the resulting image file and timestamp are transmitted to the destination or destinations using the available communications path or network. Typically, the maximum frame rate thus transmitted is slower than that possible with conventional motion-video encoding algorithms, but is faster than would be possible with high-resolution (e.g., 704×480) source images. Frame rates of approximately 5 frames/second are typical, yielding a good perception of motion at reasonable transmission bitrates.

The time stamps appended to each discrete image file thus produced facilitate reproduction of the individual images in the sequence. Further, when transmission of the image through typical communications networks involves significant and variable delay in the image transmission, the time stamps provide a means for the reproducing device to display each individual image in correct temporal sequence. The time stamp represents the time at which the image was captured, as measured by a suitable time base inside the camera. This time base may be provided by the camera's operating system. Alternatively, the time stamp may be derived from a running count of the incoming video frames from the source.

The invention supports simultaneous use of several communication channels with different bandwidths. By way of example, a security and surveillance LAN might typically be an Ethernet or equivalent network that will support data streams of up to perhaps 100 Mb/sec. Other monitoring stations may view video from selected cameras. However, these monitoring stations are geographically remote from the server, and they connect to the server via as variety of communications channels, such as, by way of example, a satellite link. Such a communications channel may be limited in bandwidth, typically supporting bitrates of perhaps 64 kilobits/second. Yet other monitoring stations may be connected to the server via different communications channels which may support greater bandwidths, perhaps up to a few megabits/second.

In the present invention, the cameras additionally produce multiple copies of each still-frame image, each copy having a different source format and encoding parameter set, with the goal of creating different compressed file sizes. Each of these different versions of each still-frame image are sent to the networked server. When one of the monitoring stations places a request to the server for a particular video stream, the server determines which version of the still-frame data stream is appropriate for that particular communications channel, and forwards that version to the requesting monitoring station.

For example, one monitoring station may send a request to the server to view a still-frame image sequence from a specific camera via a satellite link communications path having a maximum capacity of only 64 kbits/second. The server, in response to the request, selects the lowest available bitrate version of the still-frame sequence from the selected camera, and forwards it to requesting monitoring station. Meanwhile, second monitoring station may place a similar request. Its associated communications channel has a maximum capacity of 1.5 M bits/second. The server accordingly selects a higher bit-rate version of the selected camera's still-frame data stream, and forwards it to second monitoring station. In general, the server has been pre-configured with a table describing the maximum capacity of each communications path, and the server selectively forwards still-frame data streams which will not exceed the capacity of the particular communications channel associated with each monitoring station.

The invention is adapted for use with communications networks having widely differing, non-interoperable protocols. This expands the utility of these disparate networks as media for conveying compressed video image sequences. For example, mobile security personnel may be equipped with cellular phones capable of displaying compressed video image sequences, yet may be unable to receive said sequences due to the disparity in communications protocols between the originating network and the mobile personnel's cellular network. Conversely, the mobile security personnel may be in a vehicle equipped with a camera and CDPD modem, but is unable to convey captured images or image sequences to a monitoring station due to protocol incompatibility between his CDPD network and the monitoring station's IP network.

The subject invention includes a multi-protocol communications switch into which a variety of media interface cards are inserted. The communications switch includes an interface structure common to all the interface cards and may be time-division-multiplexed, or may be space-multiplexed, or a combination of both. In one implementation, the switch contains a collection of high-speed serial communications pathways, which may be interconnected via an intelligent cross-point switch mechanism. Data is then routed between the various cards under intelligent control. In the case of an IP implementation, data between the interface cards may be routed as necessary using familiar IP switching and routing protocols and algorithms.

The multi-protocol switch may be used for data and audio transmissions as well as for image transmission. An additional feature and function of the multi-protocol switch allows data to be interchanged between media card slots, in addition to the basic function of routing data to and from the extended network. Thus, visual or audio data, or indeed other data types, may be exchanged between a variety of otherwise incompatible device types.

The present invention improves the flexibility of the camera, by providing a greater degree of choice of image resolution, frame rate, overall quality, and bitrate. The camera may apply a plurality of compression schemes to the production of a sequence of still-frame images of varying bitrate. Thus, remote monitoring stations over limited-bandwidth communications paths are able to select a version of the camera's imagery compatible with the bandwidth limitations. Simultaneously, monitoring stations enjoying wider-bandwidth communications paths may select a higher-bitrate version of the same imagery, and enjoy greater image resolution or quality.

In the present invention, all of the video compression schemes are configured by software to produce a video format compatible with the communications capacity of current users. Specifically, instead of selecting compression schemes dedicated to a particular type of video compression as in the prior art, the software instead determines what type of compression is currently required by the various monitoring stations, based on the associated communications bandwidth. Thus, a compression scheme may be dynamically re-configured, by software, to stop sending high-bitrate MPEG motion video if there are no current viewers thereof, and may instead be configured by software to compress the video into a Motion-JPEG format, as appropriate to a (new) monitoring station with limited bandwidth.

This dynamic mapping of available compression resources need not be limited to video compression alone. Audio, as associated with a particular camera, may also be digitized, compressed, and transferred via network to a monitoring station. The audio may be compressed to different degrees, resulting in different audio bit-rates. As with video, this degree of compression is under the dynamic control of the camera's application software. Monitoring stations with limited-bandwidth communications paths may required a lower-bitrate replica of the captured audio, while monitoring stations enjoying more robust communications paths preferably receive audio with a higher bitrate, and accordingly higher perceived quality.

It is, therefore, an object and feature of the subject invention to provide a signal transmission system capable of sending different resolution signals from a source to a remote location based on the capacity of the transmission channel.

It is also and object and feature of the subject invention to provide a signal transmission system capable of sending different resolution signals from a source to a remote location based on the capability of the remote location.

It is a further object and feature of the subject invention to provide a system for generating multiple resolution signals whereby the signals of multiple resolution may be selectively transmitted to multiple remote receivers.

It is an additional object and feature of the subject invention to provide a system that permits a single source to generate high-resolution still images, lesser resolution still images and streaming video for transmission to selective receiving stations.

It is a further object and feature of the invention to provide a system capable of transmitting a signal to a remote station using any of a plurality of selective protocols.

It is an object and feature of the subject invention to provide an image collection and transmission system supporting the use of a wireless “Video Enabled” handset such as cellular telephones connected to a situational awareness system to view video and other sensors.

It is another object and feature of the subject invention to provide an image collection and transmission system supporting the use of a wireless “Video Enabled” handset such as cellular telephones connected to a situational awareness system to view video and other sensors at the same time that they are being monitored at a faster refresh rate on a wide-band LAN/WAN.

It is another object and feature of the subject invention to provide an image collection and transmission system supporting the use of a wireless “Video Enabled” handset such as cellular telephones connected to a situational awareness system to view video and other sensors at the same time that they are being monitored at a faster refresh rate on a wide-band LAN/WAN by use of multiple parallel formats.

It is another object and feature of the subject invention to provide an image collection and transmission system supporting the use of workstations with communications over Frame Relay ISDN or INMARSAT connected to a situational awareness system to view video and other sensors at the same time that they are being monitored at a faster refresh rate on a wide-band LAN/WAN by use of multiple parallel formats.

It is an object and feature of the subject invention to provide a single source camera for generating intermixed full motion (such as MPEG 1, 2, or 4) and step-motion (such as M-JPEG) streams.

It is an object and feature of the subject invention to provide a single source camera capable of generating both video streams (such as MPEG 1, 2, or 4) and step motion (such as M-JPEG) covering the same time frame to facilitate high bandwidth and low bandwidth distribution.

It is an object and feature of the subject invention to provide a single source camera capable of generating Multiple Video and/or Step Video Streams of different formats plus audio.

It is an object and feature of the subject invention to provide a system incorporating camera-generated time stamps, appended to sequentially-captured still-frame images transmitted through a communications network, to facilitate image sequence playback in the correct temporal order and at the correct temporal rate.

It is an object and feature of the subject invention to provide a system permitting the derivation of time stamps from a free-running time base within the camera.

It is an object and feature of the subject invention to provide a system permitting the derivation of time stamps from a running count of incoming video frames.

It is an object and feature of the subject invention to provide a system for supporting an Audio Stream on Playback with any of the Video and/or Step Video Streams to provide synchronized audio with the video/step video.

It is an object and feature of the subject invention to provide a system for supporting simultaneous encoding of a given source video frame using several effective source resolutions, producing several corresponding output files of different size.

It is an object and feature of the subject invention to provide a system for simultaneous encoding of a given source video frame using several differing degrees of compression, again producing several corresponding output files of different size.

It is an object and feature of the subject invention to provide a system for use of either or both of the above two items, on a regular, periodic cycle to produce a sequence of still images visually representative of motion at various overall bit rates.

It is an object and feature of the subject invention to provide a system supporting the periodic capture and compression of sequential video source images using the two techniques described above, including a mechanism to guarantee that a pre-defined maximum bitrate for any given channel is never exceeded.

It is an object and feature of the subject invention to provide a system for supporting the use of a transmit buffer “fullness” to drive the selection of Q's for the next image sent (open loop to monitor).

It is an object and feature of the subject invention to provide a system supporting step video (such as M-JPEG) is provided in a plurality of Q's such that a stream of a particular bandwidth can be selected based on the capacity of the particular communications channel selected.

It is an object and feature of the subject invention to provide step video (such as M-JPEG) is provided in a plurality of Q's such that Q's can be dynamically selected on a case by case (such as frame by frame) basis such that a maximum bandwidth is not exceeded, yet the best Q′ is used while maintaining a constant frame rate.

It is an object and feature of the subject invention to provide a system for supporting the use of a rebroacaster element, either stand alone or on a server, to build a stream for a particular bandwidth circuit.

It is an object and feature of the subject invention to provide a system for supporting the use of multiple rebroadcasters or multi-channel rebroadcaster to build a plurality of streams for channels of different bandwidths.

It is an object and feature of the subject invention to provide a system for supporting the use of a multicast datagram format for transmission of still-frame imagery via a packet-based network, to allow said imagery to be simultaneously viewed on multiple monitor stations.

It is an object and feature of the subject invention to provide a system for supporting the use of a multicast datagram format for transmission of still-frame imagery via a packet-based network, to allow said imagery to be archived, viewed, analyzed, or otherwise processed simultaneously by several network-based devices.

It is an object and feature of the subject invention to provide a system supporting the use of a multicast-to-unicast protocol converter to allow still-frame image sequences, originally transmitted using a multicast network protocol, to be converted into a unicast format for transmission through various communications pathways otherwise not well suited to multicast traffic.

It is an object and feature of the subject invention to provide a system for supporting the use of a unicast-to-multicast protocol converter to allow forwarding of still-frame image sequences, originally received using a network unicast protocol, to be forwarded to one or more receiving devices using a multicast format.

Other objects and features of the invention will be readily apparent from the accompanying drawings and detailed description of the preferred embodiment of the invention.

### BRIEF DESCRIPTION OF THE DRAWINGS

FIG. 1 is a block diagram of the subject invention showing the incorporation of multiple compression schemes in advance of the network interface.

FIG. 2 is a block diagram illustrating multiple monitor and receiving stations having a plurality of transmission systems and protocols.

FIG. 3 is a flow chart illustrating the methodology of the subject invention.

FIG. 4 is a modified flow chart showing decision blocks.

FIG. 5 is a simplified version of the system of the subject invention showing multiple communication links.

FIG. 6 is an expanded version of a system similar to that shown in FIG. 5.

FIG. 7 is a further expanded version of the system.

FIG. 8 is a version of the system for aircraft to ground connectivity.

FIG. 9 depicts how the low-bandwidth compressed still-frame sequences may be disseminated via a ground-based network upon receipt.

FIG. 10 depicts a multi-protocol communications switch and router.

FIG. 11 depicts an adaptation of the multi-protocol communication switch for interoperation between different media types.

FIG. 12 depicts a mobile application of the multi-protocol communications switch.

FIG. 13 is a circuit diagram of an analog video front-end/digitizer.

FIGS. 14, 15 and 16 comprise a circuit diagram for video compression engine comprising a commercially-produced ASIC which can be programmed to produce MPEG, JPEG, or motion JPEG output stream formats under software control.

FIG. 17 shows the analog audio digitizer.

FIGS. 18-21 depict the system processor.

FIGS. 22 and 23 processor's RAM and Flash ROM, respectively.

FIG. 24 depicts the processor's Me'ia Independent Interface (MII) connection arrangement to the Ethernet Physical-Layer Interface (PHY).

FIG. 25 depicts the PHY.

FIGS. 26 and 27 depict the system power supply, operable to receive operating power from the Ethernet cabling plant.

FIG. 28 depicts the processor's boot-time option programming arrangement.

FIG. 29 illustrates a system showing a still-frame image sequence transmitted as a multicast stream for reception by several devices on a network.

### DETAILED DESCRIPTION OF THE PREFERRED EMBODIMENT

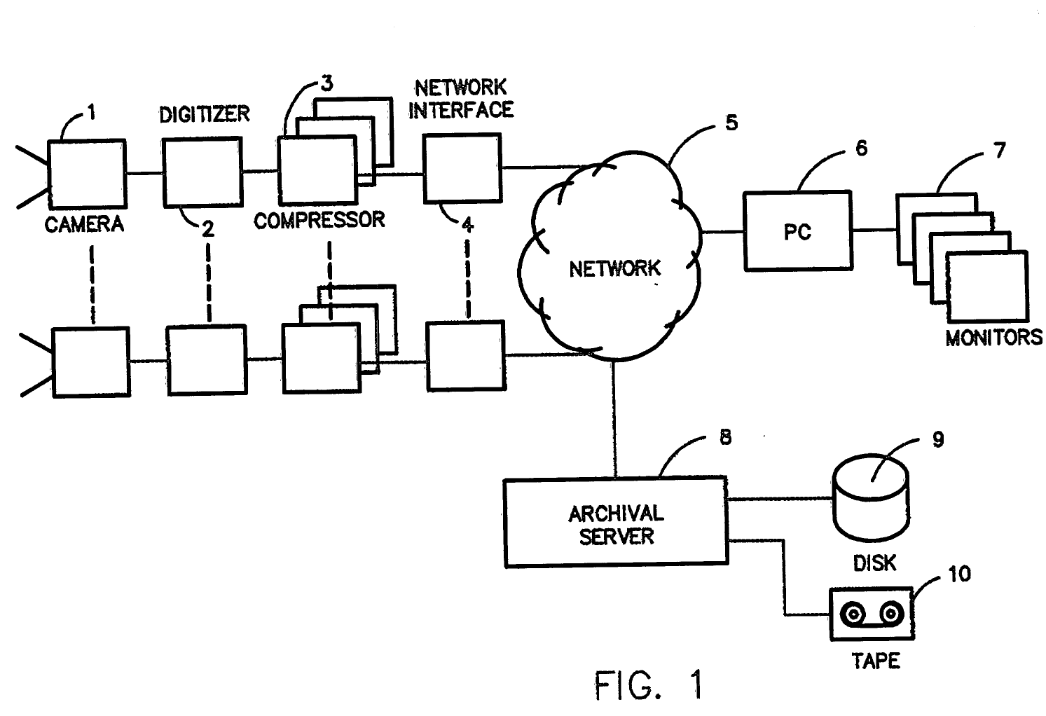

FIG. 1 is an illustration of the prior art and illustrates this overall concept. A number of cameras 1 are disposed around a location to be monitored. Each camera produces a video signal representing the scene of interest. The video signal is digitized by digitizer 2, compressed by compressor 3, and transmitted to a network 5 via network interface 4. In the invention, multiple compressors 3 are employed to compress the captured image into a plurality of different compressed signals, representing different degrees of image resolution, compression type, or compressed bit rate. These multiple video streams may be combined into one composite stream for network transmission, or may be maintained as separate and distinct video or still frame streams throughout the network.

Note that the digitizer, compressor, and network interface can be integral to a camera housing, or can be housed separately such as in a Video Encoder.

Video or images thus networked may be selectively viewed on an operator's console consisting of PC(s) 6 and monitor(s) 7, or may be received by a networked server 8 for storage, analysis, and subsequent retrieval via disk storage 9 or tape storage 10.

In the disclosed invention, cameras use the popular Ethernet networking protocol. Using the familiar OSI hierarchy, Ethernet is used for the physical layer, and UDP/IP is used for the network and transport layers. Networks may be wire, fiber or wireless. Other network protocols and topologies may also be utilized.

The previously incorporated patent applications describe a camera which simultaneously produces one or more compressed motion-video data streams, which are then conveyed via a network to one or more monitoring stations. In the prior applications, a series of high-resolution compressed still-frame images is also produced, for the primary purpose of archiving high-resolution compressed still-frame images. In the preferred embodiment, the images were compressed using the JPEG algorithm. In the present invention, these still-frame images are used for a different purpose—to provide a very-low bandwidth alternative to motion video data streams, for those situations where a low-bandwidth communications channel is being used.

In the invention, fully described below, generation of these low-bitrate video images is moved into the camera, and these low-bitrate video image sequences are created simultaneously with the high-bitrate video signals. The low-bitrate video signals may then be transported through and between networks, using commonplace low-bandwidth communications channels. Using the invention, remote cameras, or remote monitors, may operate over low-bitrate communications channels or terminals including:

ISDN telephone lines. Typical capacity is 128 kbps.

Frame Relay circuits.

Dial-up modem circuits. Typical capacity is 56 kbps.

Government or military tactical radios, typically 16 kbps.

Public Service Radios

Commercial Radio (Business, Trunking, and the like.)

Cellular phones

Blue-Tooth wireless LAN's

IP-Network telephones, with graphic displays

Networked handheld devices such as Personal Digital Assistants (PDA's)

PDA's equipped with embedded cameras

Wrist monitors or cameras

Heads-up monitors, or head-mounted cameras

Monitors integrated into vehicles, such as the On-Star™ system

Other embedded cameras, such as are used in Shipping Monitoring, Process Control monitoring, Animal Monitoring, Vehicle monitoring, Child monitoring, Employee monitoring, Sports monitoring, Asset monitoring, Transportation monitoring, Elevator monitoring, etc.

Sequential Still-Frame Transmission

In the invention, incoming video is captured at a high resolution (704×480), and decimated-by-two to yield a SIF resolution (352×240) source image resolution. The image may alternatively be decimated-by-four to yield a QSIF source resolution. In either case, individual, complete frames are then compressed, using a still-image compression algorithm such as JPEG. With a dedicated ASIC to perform the compression, each individual image may be compressed in less than 100 milliseconds (this includes the time required for a complete frame of composite video to be delivered to the ASIC). A time stamp is then added to each image file. Finally, the resulting image file and timestamp are transmitted to the destination or destinations using the available communications path or network. Typically, the maximum frame rate thus transmitted is slower than that possible with conventional motion-video encoding algorithms, but is faster than would be possible with high-resolution (say, 704×480) source images. Frame rates of approximately 5 frames/second are typical, yielding a good perception of motion at reasonable transmission bitrates.

The time stamps appended to each discrete image file thus produced are needed to facilitate reproduction of the individual images in the sequence. The exact time of capture of each image may vary slightly from frame to frame, depending on variables such as the camera's processor overhead, amount of picture detail in the scene, and the like. In addition, transmission of the image through typical communications networks involves significant and variable delay in the image transmission. The time stamps thus provide a means for the reproducing device to display each individual image in correct temporal sequence. The time stamp represents the time at which the image was captured, as measured by a suitable time base inside the camera. This time base may be provided by the camera's operating system. Alternatively, the time stamp may be derived from a running count of the incoming video frames from the source.

Intelligent Server to Selectively Forward Images Based on Available Bandwidth in One or More Communication Channels

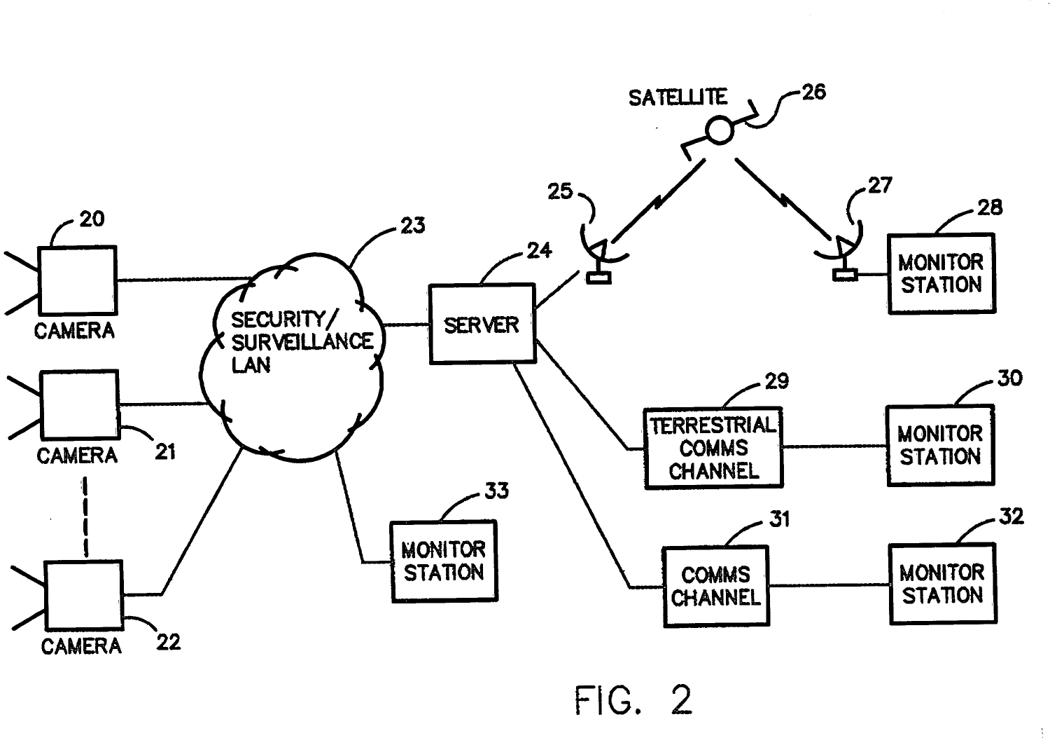

An enhancement to the above invention supports simultaneous use of several communication channels with different bandwidths. Referring to FIG. 2, cameras 20, 21, and 22 are attached to a facility's security and surveillance LAN 23. Such a LAN might typically be an Ethernet or equivalent network, and will support data streams of up to perhaps 100 Mb/sec. A server 24 resides on the network, and receives the image data streams produced by cameras 20 through 22. A video monitoring station 33 is also attached to the LAN, and may view selected video streams produced by a selected camera.

Other monitoring stations 28, 30, and 32 may view video from selected cameras. However, these monitoring stations are geographically remote from the server, and they connect to the server via as variety of communications channels. In the example shown, monitoring station 28 connects to server 24 via a satellite link comprising ground station 25, satellite 26, and second ground station 27. Such a communications channel may be limited in bandwidth, typically supporting bitrates of perhaps 64 kilobits/second. The other monitoring stations 30 and 32 are connected to the server via different communications channels 29 and 31 respectively. These communications channels may support greater bandwidths, perhaps up to a few megabits/second.

Cameras 20, 21, and 22 each produce a sequence of still-frame images as previously disclosed. In the present invention, the cameras additionally produce multiple copies of each still-frame image, each copy having a different source format and encoding parameter set, with the goal of creating different compressed file sizes. Each of these different versions of each still-frame image are sent to the networked server 24. When one of the monitoring stations 28,30, or 32 places a request to the server for a particular video stream, the server determines which version of the still-frame data stream is appropriate for that particular communications channel, and forwards that version to the requesting monitoring station.

For example, monitoring station 28 sends a request to server 23 to view a still-frame image sequence from camera 20. The satellite link communications path 25-26-27 has a maximum capacity of only 64 kbits/second. The server, in response to the request, selects the lowest available bitrate version of the still-frame sequence from camera 20, and forwards it to monitoring station 28. Meanwhile, monitoring station 30 places a similar request. It's associated communications channel has a maximum capacity of 1.5 M bits/second. The server accordingly selects a higher bit-rate version of the camera's still-frame data stream, and forwards it to monitoring station 30. In general, the server has been pre-configured with a table describing the maximum capacity of each communications path, and the server selectively forwards still-frame data streams which will not exceed the capacity of the particular communications channel.

Note that the different monitoring stations can receive different copies of the same still-frame sequence, and that each copy can have different source video resolution, encoding parameters, and/or a different frame rate. For example, monitoring station 28 has the lowest available communications bandwidth, and will therefore receive a still-frame sequence with the lowest source resolution, lowest frame rate, and the most aggressive compression. Monitoring stations enjoying greater communications bandwidth will receive the same still-frame sequence, but at higher source resolution, greater frame rate, and/or less severe compression.

Note that more than one monitoring station with similar bandwidth requirements cam receive the same copy of the still-frame sequence. There is no requirement to generate duplicate copies of the image in this case.

Simultaneous Coding of Still Frame Video Images with Different Degrees of Compression

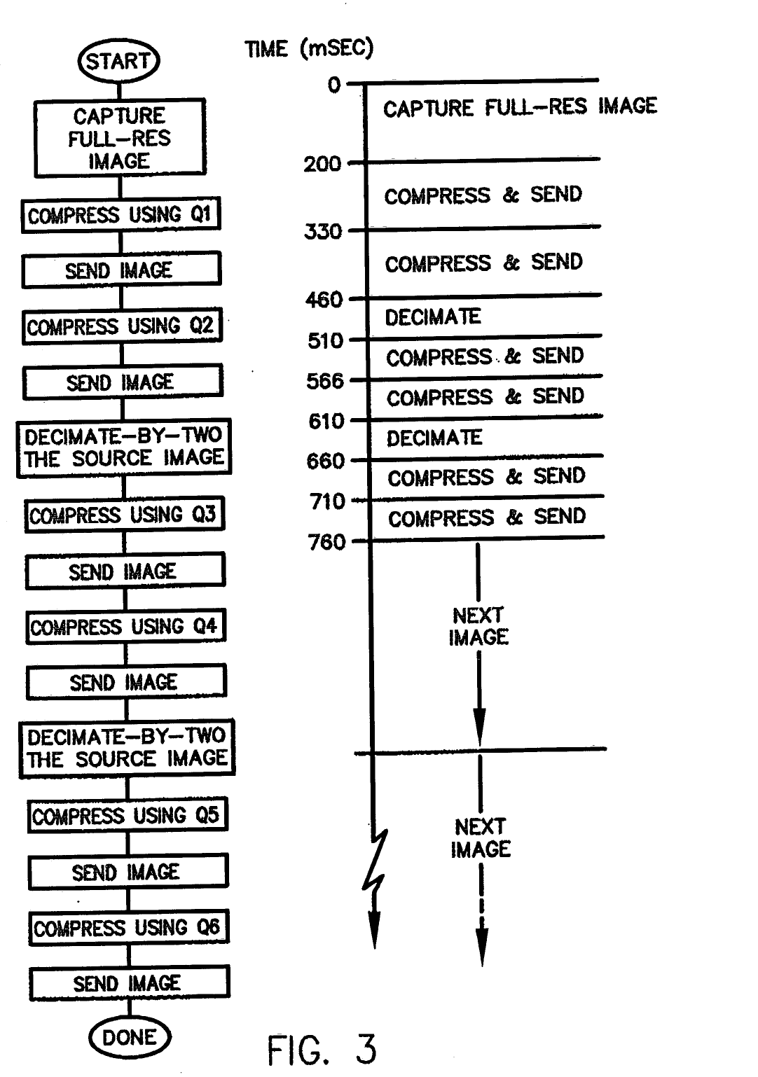

In FIG. 2, each camera produces several copies of a still-frame sequence, each copy having different source resolution, amount of compression, and/or different frame rate. FIG. 3 illustrates this aspect of the invention in greater detail.

The flowchart illustrates the sequence of events. At time T=0, the camera initially captures an image at full source resolution, say 704×480 pixels. This image may take significant time to capture and transfer to the compressor's internal memory. Once the image has been captured into the compressor's memory, the image is compressed twice. The first time the image is compressed, a predetermined variable Q is set to a value which yields a small degree of compression of the source image, thus preserving image quality at the expense of a larger output file size. When the compression is complete, the resulting image data is sent to the camera's network stack, for subsequent transmission to the networked server. The value of Q is then changed to a different predetermined value that represents more aggressive compression, and the original source image is compressed again. This second compression of the original source image results in a smaller image data file. Again, this data is transferred to the network stack for transmission to the server.

Next, the original source image, still in frame memory, is decimated by two in both the horizontal and vertical axes. This yields an image with SIF resolution, reducing the source file size by a factor of 4. The source image is again compressed twice, using a ‘soft’ degree of compression and a more aggressive degree of compression. Again, both versions are sent to the server.

Finally, the source image in the frame memory is again decimated-by-two, resulting in a QSIF image in the frame memory. Again, the image is compressed twice, with two different degrees of compression. Upon completion, a new source image is captured into frame memory at full source resolution (704×480), and the cycle repeats.

As a result of the above process, the source image has been compressed six separate times, and six different versions of the source image have been transferred to the server. Since these images exist in a variety of different resolutions and image file sizes, the server may, as described above, select and forward a copy of the image appropriate to the bandwidth limitations of any particular communications channel.

Note that the selection of six different compression cycles is somewhat arbitrary. An inherent tradeoff exists between the total number of compression cycles, and the maximum frame rate that the cycle can support. For example, in FIG. 3 the total cycle time is approximately 760 milliseconds, yielding a frame rate of approximately 1.3 frames/second. The algorithm described above may be modified to produce fewer different copies of the image, and thereby enjoy a shorter cycle time & correspondingly higher frame rate. In particular, the full-resolution image capture and compression cycles occupy the largest time blocks in the sequence; eliminating one or both would shorten the cycle time and improve the frame rate. This tradeoff may be made to be user-configurable, allowing the user to trade off frame rate with the number of different image replicas produced.

Automatic Adjustment of Compression Parameters to Fit Image Stream Into Bandwidth-Limited Channel

The file size of a compressed image is not readily predictable, and is highly dependent on the scene content of the image being compressed. As the scene content changes, the resulting compressed file size changes. This presents a serious problem when attempting to convey a sequence of such images over a constant-bandwidth communications medium.

As the image files are transmitted across the constant-bandwidth communications channel, it is necessary to keep the average image bit rate less than that of the communications channel. If the average image bitrate exceeds the capacity of the communications channel, the received images will ‘lag’ progressively, until the transmitter's buffer overflows. If the average bitrate is less than the capacity of the communications channel but the instantaneous bitrate is bursty (such as when highly-detailed objects pass through an otherwise static scene), then the actual delivery time of the image file to the monitoring station will be variable. The resulting still image file sequence may appear choppy when displayed. This problem may be overcome by adding some image buffering in the receiver, but this adds additional delay to the signal path.

A typical solution to this problem is to capture and compress the source images at some pre-defined frame rate, while monitoring the level of a transmit buffer. If the transmit buffer begins to fill excessively, individual compressed frames may be discarded as necessary to maintain the desired channel data rate. While this approach does successfully guarantee that the channel's capacity is never exceeded, it does so at the expense of dropped frames. This is undesirable. It is visually annoying, and during post-event analysis the dropped frames may have contained valuable visual information.

The present invention overcomes these deficiencies by guaranteeing that the various compressed still-image files transmitted to the server do not exceed some specified maximum file size. This maximum image file size is defined individually for each of the several image files generated during each cycle depicted in FIG. 3. In other words, during each cycle, several compressed image files are created, and each of these files is guaranteed not to exceed some individually-specified maximum file size. This is accomplished at the expense of a slightly reduced maximum frame rate, as will be described.

In the previously described algorithm (FIG. 3), only one effort is made to compress the image at each setting of source resolution & compression setting. The algorithm makes no effort to confirm that any particular image is less than some specified maximum file size. As a result, some particular images may exceed the instantaneous capacity of it's associated communications channel.

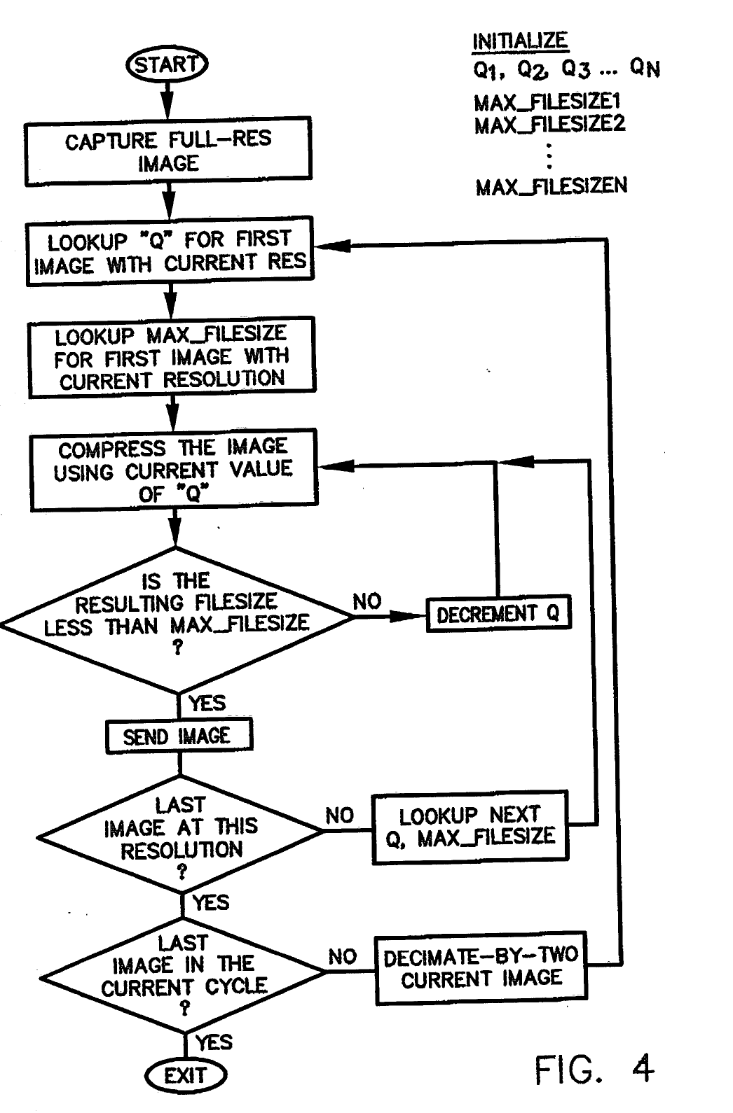

In FIG. 4, the flowchart is modified with a decision block after each image compression. In the decision blocks, the compressed image file size is compared with some predetermined maximum file size, as previously defined for that particular image in the sequence. If the compressed image file size exceeds the pre-defined maximum, then the relevant compression variable ‘Q’ is decremented, and the source image is compressed again. This process repeats until the resulting compressed image file size is less than the predefined file size.

The algorithm continues until each image in the sequence has been successfully compressed. Note that the above algorithm may require longer cycle times that the previous algorithm, since some images may need to be compressed more than once. In practice, this additional cycle time need not be particularly burdensome; for example with SIF images the average time to compress an image is typically 50 milliseconds, and the time to compress a QSIF image is typically less than 10 milliseconds. Thus, additional compression cycles do not materially reduce the overall frame rate.

Video Surveillance Network Extended by Use of a Low-Bandwidth Communications Channel to Support Remote or Mobile Cameras and Monitoring Stations

The basic video surveillance network of FIG. 1 has been the subject of several prior disclosures. When enhanced with the inventions described above, the utility and scope of the video surveillance network may be significantly improved.

For example, a number of handheld cell phones are now available which include video displays. As a current example, the Sony/Ericsson P800 boasts a color QSIF-resolution (176×144) display. Such a cell phone would be of tremendous utility in the described video surveillance network, allowing mobile personnel to select and view the various cameras and sensors throughout the network, or interconnected networks. Such video displays are capable of rendering video images or sequences thereof, but the bandwidth limitations of the cellular communications prevent this. While a variety of cellular network topologies are in current use—AMPS, CDPD, PCS, and GSM primarily, none of these topologies provide sufficient bandwidth to support transmission of high-resolution, full-motion video. The present invention provides a solution, allowing such cell phones to display sequences of still images, without the need for a high-bandwidth communications path. Such a capability would be of great utility in security/surveillance networks, providing roving security personnel with access to cameras upon demand. In addition, police, fire, or other public service personnel would be able to survey scenes of interest while in route to a fire or accident site, for example.

Note that the present invention additionally provides a means for such a cell phone, or other low-bandwidth terminal, to transmit a low-bitrate compressed image sequence. Thus, mobile cell phones can use the present invention to capture image sequences, and transmit them to networked monitoring stations via a bandwidth-constrained communications channel.

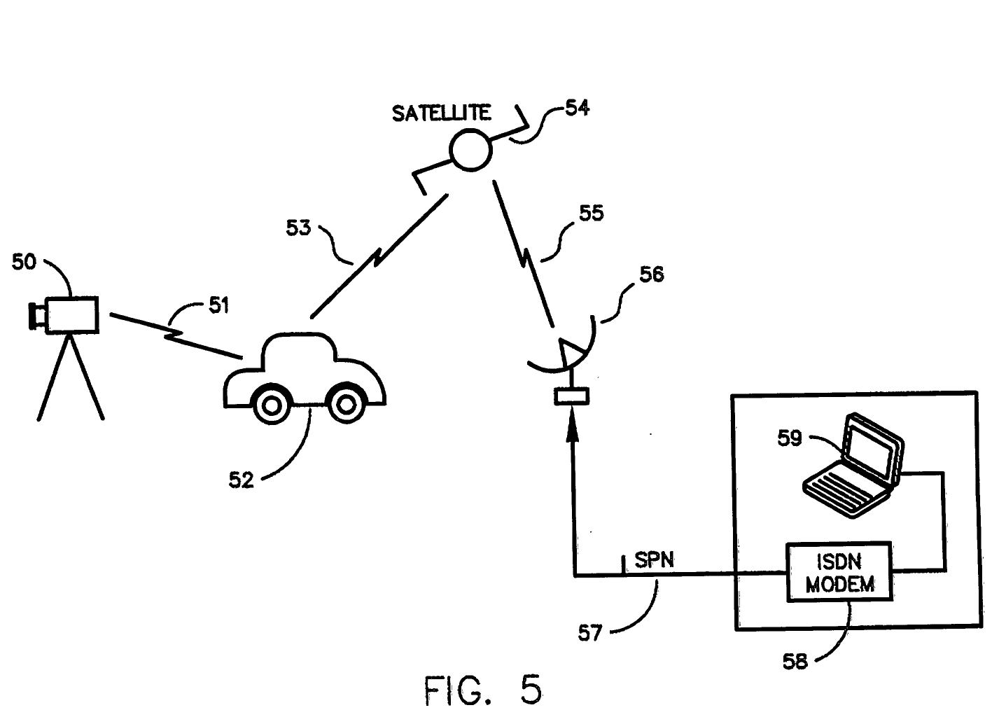

FIG. 5 depicts a simple configuration using the foregoing inventions. At some remote location, a networked surveillance camera 50 views some scene of interest, and passes the previously-described compressed video signals to vehicle 52 via communications path 51. The immediate communications path 51 at the remote location may be wired or wireless, as needed. A typical configuration might involve an industry-standard IEEE 802.11 wireless link, or may be a physical cable such as used in ordinary Ethernet IEEE 802.3 networks.

Vehicle 52 is assumed to be equipped with a suitable communications router or switch. Inside the vehicle a modem (not shown) adapts the local network traffic to a form suitable for the satellite uplink 53. Typically, such mobile satellite systems support an ISDN channel, allowing dial-up service across the satellite communications channel. Video data is thus passed through the vehicle's modem, the uplink 53, satellite 54, and downlink 55 to ground station 56. A final ISDN channel 57 passes the camera's selected video signal to monitoring station 59 via ISDN modem 58.

Due to the bandwidth constraints of the satellite channel, commonplace motion video protocols such as MPEG may not be possible, or may produce motion video signals of poor quality due to the severely limited available communications bandwidth. However, using the previously-described invention, higher-resolution still-frame sequences may be conveyed over the communications channel.

Note that the previously-described invention is useful with any low-bandwidth communications channels, such as are commonly encountered for example, in tactical battlefield situations or across terrestrial dial-up circuits.

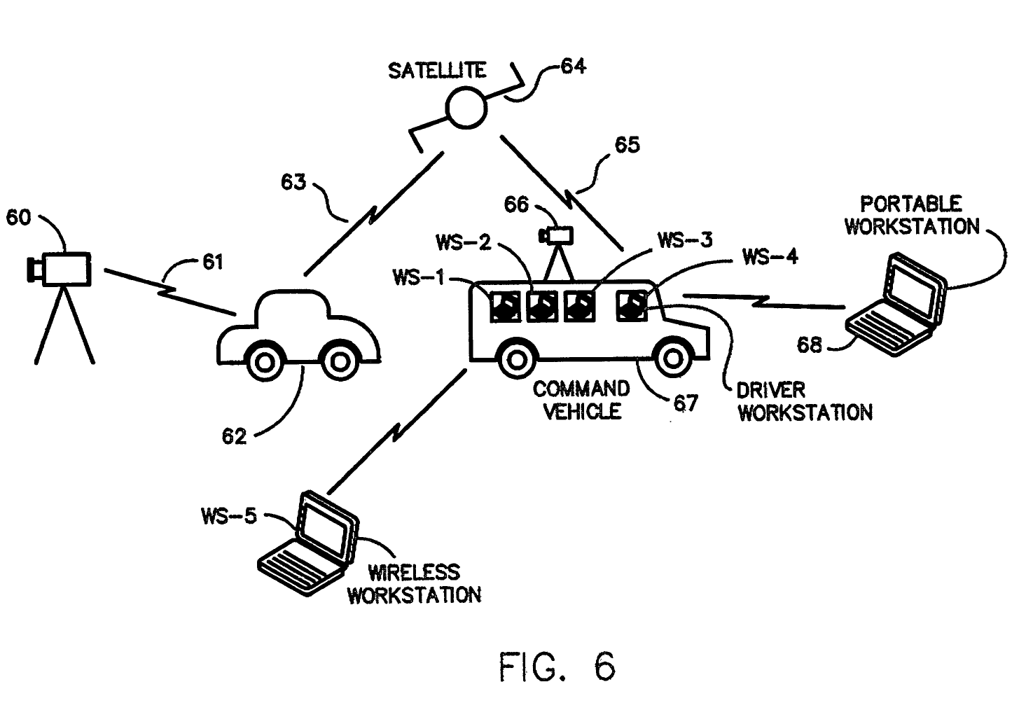

FIG. 6 depicts a more elaborate configuration of the surveillance network. As in the previous example, a camera 60 passes compressed video data to vehicle 62 via local communications path 61. Selected video data is then passed via uplink 63 to satellite 64, thence via downlink 65 to command vehicle 67. Command vehicle 67 is equipped with a video surveillance network as previously described. It contains several monitoring stations shown as WS1, WS2, WS3, WS4, and WS5. Note that monitoring station WS5 connects to command vehicle 67 via a wireless data link, such as the popular IEEE 802.11. Command vehicle 67 additionally supports a portable workstation 68, and a networked video surveillance camera 66.

Operators at the various monitoring stations at the command vehicle may select a remote camera, for example camera 60, and view the camera's still-image sequences via the intervening bandwidth-limited satellite communications link. The monitoring stations may, alternatively, select a local camera, such as local camera 65, and view the camera's video as a full-motion video scene. Full-motion video is possible in this instance, since the camera is local and the available communications bandwidth is much larger. Typically, said communications path consists of a 100 megabit-per-second local area network, such as IEEE 802.3 Ethernet.

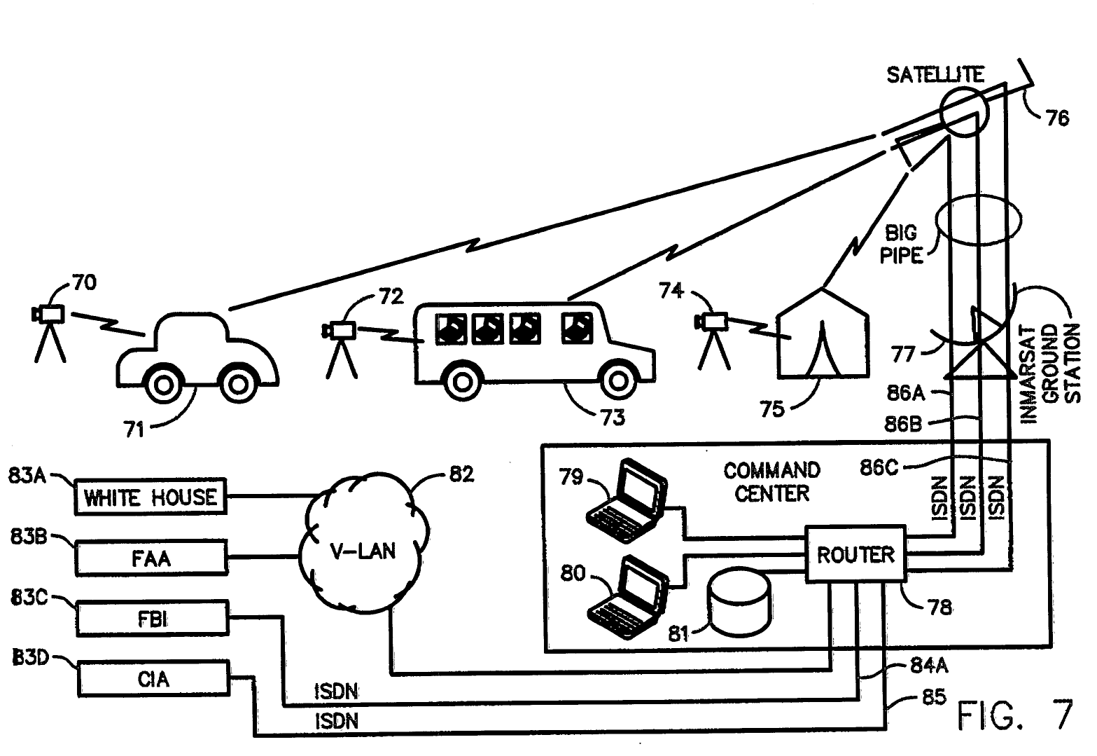

FIG. 7 depicts another elaboration of the invention. In this system configuration, several remote or mobile locations are connected to a centralized site and network via a bandwidth-constrained satellite communications link. Remote camera 70 passes compressed video data to a satellite uplink via vehicle 71, which is assumed to contain a suitable channel modem. Remote camera 72 likewise passes compressed video data to the uplink via vehicle 73, and remote camera 74 passes compressed video data to the uplink via communications tent 75. As previously described, these uplink signals often convey a dial-up ISDN channel to the satellite 76. In the satellite's downlink, these various ISDN channels may be aggregated into a single, larger channel for efficiency of transport and switching. At the ground station 77, the various compressed video data channels pass through router 78, which selectively passes the various camera video streams to one or more of several destinations. As shown, monitoring stations 79 and 80 are located at a Command Center, allowing operators to select and view video from a variety of remote cameras. Disk storage 80 is provided to allow selected incoming video signals to be archived. Router 78 may also pass selected video streams to monitoring stations at a variety of other locations, via terrestrial ISDN landlines 84 or 85. Router 78 may also selectively pass video streams from a remote location to monitoring stations via a local or wide-area network or VLAN 82.

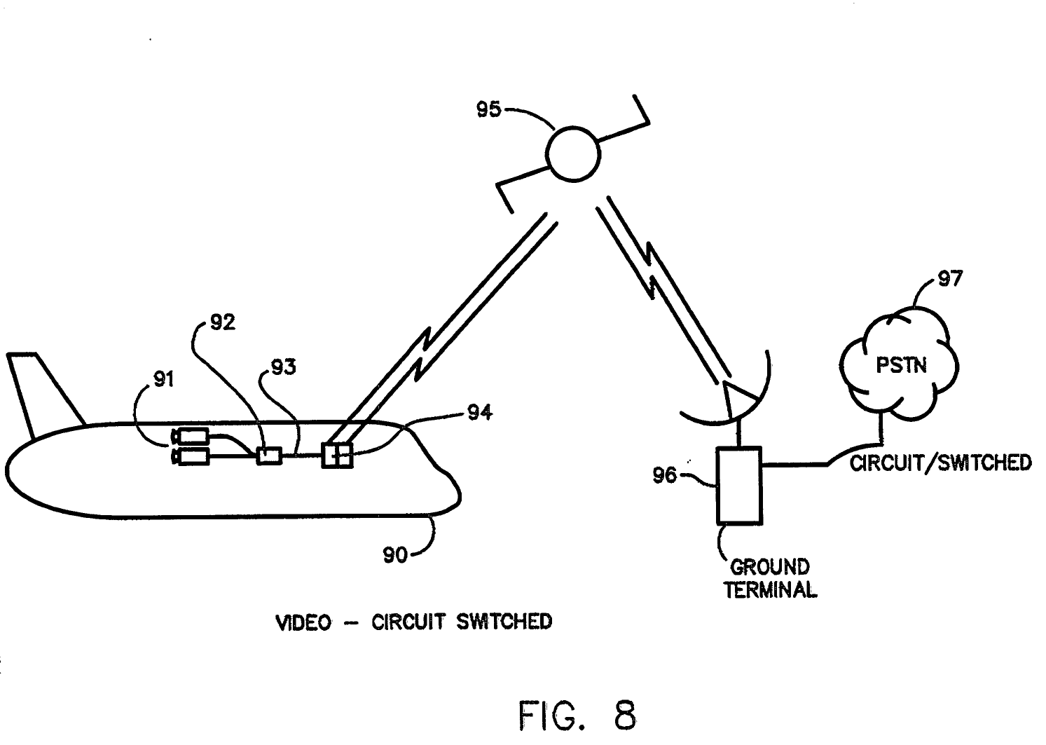

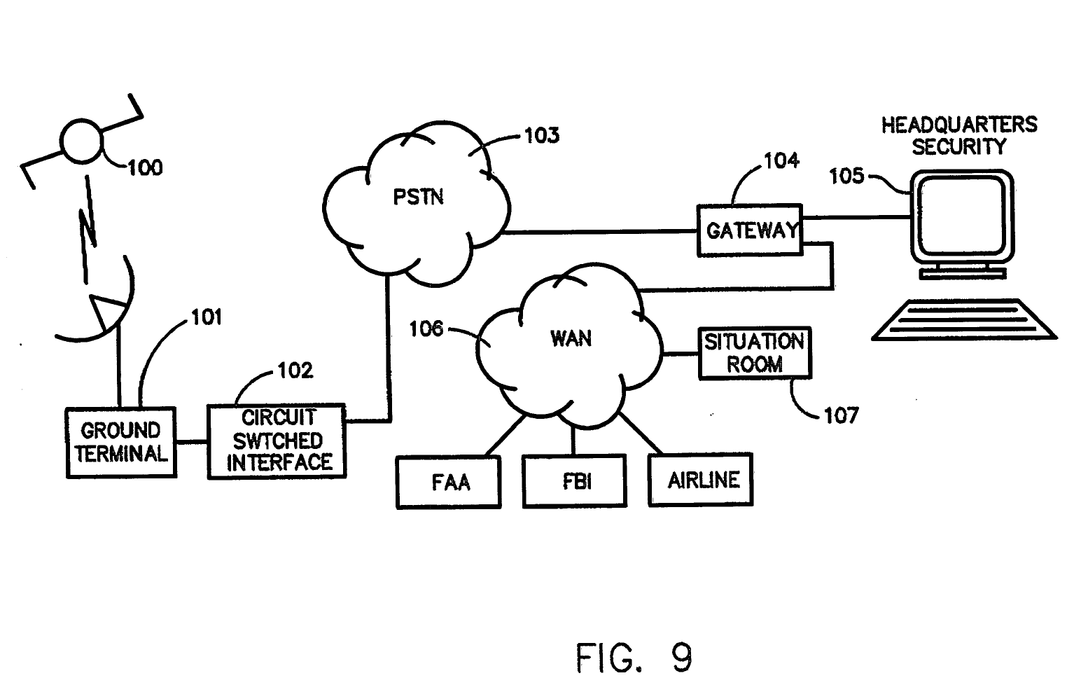

FIGS. 8 and 9 depict another elaboration of the invention, wherein the restricted-bandwidth capability of the system may be exploited for airborne applications. In FIG. 8, aircraft 90, while in flight, maintains a communications pathway with the Public Switched Telephone Network (PSTN) 97, via hub 92, airborne modem 94, satellite 95, and ground terminal 96. The ground terminal subsequently forwards the received data streams to the PSTN 97. Such a communications capability is commonplace today, and is ordinarily used to provide in-flight telephone services to passengers. The available bandwidth, however, is typically low. In practice, the per-channel bandwidth is 56 kbps or 64 kbps, providing compatibility with the ground-based PSTN 97. While adequate for the needs of a telephony service, such bandwidth is ordinarily insufficient to transport high-resolution motion video signals, even after the video has been compressed.

The previously-described invention allows these low-bandwidth communications channels to be used for video surveillance of the aircraft while in flight. In FIG. 8, cameras 91 produce the low-bandwidth still-frame compressed video image sequences as described in the foregoing description. The invention guarantees that the data streams produced by the cameras do not exceed the capacity of the available air-to-ground communications channel.

FIG. 9 depicts how the low-bandwidth compressed still-frame sequences may be disseminated via a ground-based network upon receipt. The video streams received from satellite 100 via ground terminal 101 are forwarded to a circuit-switched interface 102. This interface forwards the received data into the PSTN 103, thus allowing a dial-up connection to be made between a user with access to the PSTN, and a selected airborne camera. A user at monitor station 105, for example, may select a particular aircraft and a particular camera on said aircraft, using for example a graphical point-and-click interface on the monitoring station. The monitoring station may then connect to the selected camera by placing a call via the PSTN 103 to the circuit-switched interface 102, and subsequently to the desired camera via the previously-described satellite link. The user may then receive the image sequence from the selected camera.

Note that this low-bandwidth connection may be initiated in the other direction. For example, an on-board camera may be programmed to initiate a communications path connection to a predetermined monitoring station, when some on-board event is detected. For example, if the camera detects motion in some ‘forbidden’ area of the aircraft, or if the pilot sends some predetermined ‘emergency’ transponder code, the camera may initiate the communications path connection to the predetermined monitoring station, and begin sending the image sequences. The image sequences may be buffered is necessary, to provide the ground-based monitoring station with all available images, back to the moment of the triggering event, or indeed, images taken immediately prior to the triggering event.

Video sequence data received by ground station 101 and forwarded to the PSTN103 via interface 102 may also be disseminated to a local- or wide-area network via gateway 104. Security agencies or law enforcement agencies may thereby share the received video sequences via commonplace terrestrial networks. Operators of monitoring stations at these facilities may, conversely, initiate a connection to selected cameras within selected aircraft, again using for example commonplace graphical point-and-click methods.

Multi-Protocol Communications Switch for Routing Compressed Video Data Over One or More Available Communications Channels

The low-bitrate communications channels previously mentioned are commonplace, yet are widely varied as to signaling protocols and channel capacity. This disclosure has heretofore dealt primarily with ISDN communications channels, both terrestrial and satellite-based. ISDN provides a dial-up, circuit-switched communications channel with two independent 64 kbps sub-channels (‘B’ channels). The previously-described invention facilitates the transmission of compressed-video image sequences over such a low-bitrate communications channel.

A variety of other communications channels are widely available, both wired and wireless. These communications channels include among others:

The analog telephony switched network (POTS). When used for data transmission, this network has a capacity of approximately 50 kbps.

Wired Ethernet, IEEE802.3. On local network spans, such a network has a typical capacity of 100 Mbps.

Wireless Ethernet, IEEE 802.11. This network has a capacity of 11 Mbps under best-case conditions.

CDPD wireless, offering data rates up to 9.62 Kbps.

These communications networks use widely differing protocols, hence are not interoperable. This limits the utility of these disparate networks as media for conveying compressed video image sequences. For example, mobile security personnel may be equipped with cellular phones capable of displaying compressed video image sequences, yet may be unable to receive said sequences due to the disparity in communications protocols between the originating network and the mobile personnel's cellular network. Conversely, the mobile security personnel may be in a vehicle equipped with a camera and CDPD modem, but is unable to convey captured images or image sequences to a monitoring station due to protocol incompatibility between his CDPD network and the monitoring station's IP network.

The aforementioned applications, Ser. Nos. 09/005,931 and 09/350,197 describe a multi-protocol communications switch and router. The apparatus is capable of determining the availability a communications path over a variety of simultaneous media, and of routing calls using available channels.

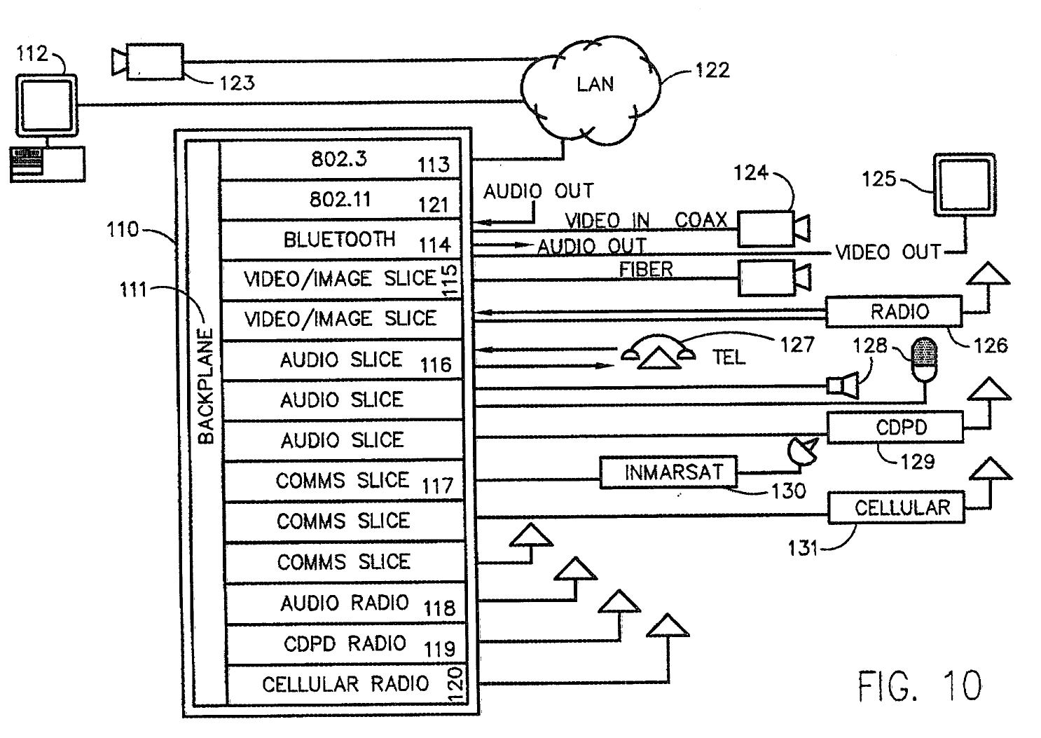

FIG. 10 depicts an elaboration of that concept. Multi-protocol communications switch 110 contains a backplane 111, into which a variety of media interface cards are inserted. The backplane contains a communications bus, using a bus structure common to all the interface cards. The bus may be time-division-multiplexed, or may be space-multiplexed, or a combination of both. In one implementation, the bus contains a collection of high-speed serial communications pathways, which may be interconnected via an intelligent cross-point switch mechanism on the backplane itself, or on a card which plugs into the backplane. In the preferred implementation, the backplane carries a localized segment of an internal LAN, using various IP protocols over an RS-485 or equivalent physical layer on the backplane. In either case, data may be routed between the various cards under intelligent control. In the case of an IP implementation, data between the interface cards may be routed as necessary using familiar IP switching and routing protocols and algorithms.

The 802.3 interface card 113 passes data selectively between the system's backplane 111 and an IEE 802.3 Ethernet segment 122. The overall switch 110 may thus be attached to a local LAN. One or more monitoring stations 112 may thereby receive data from the multi-protocol switch 110, thus providing a means to display video or audio data received via one or more of the various media. Likewise, data from one or more cameras 123, which are attached to the local LAN, may be selectively routed through multi-protocol switch 110 to a specific medium via one or more of the various media interface cards. Note that monitoring station 112 and/or camera 123 need not be directly attached to the same local LAN segment as the multi-protocol switch 110. The camera 123 or monitoring station 112 may be on a remote yet interconnected LAN segment, and the data passing to or from the monitoring stations 112 and/or cameras 123 may be routed to the multi-protocol switch 110 via commonplace internetworking protocols. Note also that alternative networking topologies may be employed, such as the IEEE 802.11 network interface card 121.

In the invention, multi-protocol switch 110 contains a variety of other interface card types, to support visual and/or audio data connections via different media types. For example, Bluetooth interface 114 supports a high-bandwidth wireless connection to local handheld devices such as Personal Digital Assistants (PDA's).

The Video/Image slice card 115 provides a wired pathway to simple analog cameras124 and/or monitors 125. The Video/Image card accepts an analog video input from said camera, digitized and compresses said video input signal, and passes the resulting video signal to the network 122 via multi-protocol switch 110. The Video/Image slice card 114 compresses the incoming video signals using the above-described invention, thus providing simultaneous streams of a given image at various resolutions and bitrates. Likewise, Video/Image slice card 115 is operable to receive similarly compressed video data from a variety of sources, including cameras 123 or any of the interface cards in the multi-protocol switch 110. Video data thus received is decoded by Video/Image slice 115, and converted into a conventional analog format for display on monitor 125.

Similarly, Audio Slice cards 116 are operable to receive digitized audio data from backplane 111, produce an equivalent analog signal, and pass said analog signal to an analog medium such as Radio 126. Conversely, Analog slice 126 is operable to receive analog audio from radio 126, and digitize and compress said audio for transmission to backplane 111 thence network 122. Audio slice card 116 effectively forms an audio gateway into and out of the multi-protocol switch 110. Note that this audio gateway is not limited to usage with a radio. As depicted, the Audio Slice card 116 may also be used with a simple telephone 127, or with a simple microphone & speaker arrangement 128. When the audio slice 116 is configured for use with a telephone, the card must provide the necessary supervisory signals including talk battery, ringing voltage, and loop current detection. When used with a microphone and speaker, audio slice card 116 provides other specific functions for that purpose, such as microphone bias and amplification, power amplification for the speaker, and acoustic echo cancellation if required. In any case, analog audio signals may be interfaced to the multi-protocol communications switch 110, and subsequently exchanged via one or more intervening and interconnected networks 112 for delivery to an audio-equipped device such as camera 123 or monitoring station 112.

Communications Slice 117 is operable to accept data from backplane 111, and to reformat said data for transmission through a selected communications pathway. For example, the Communications slice 117 may be configured to accept data to and from the backplane 111, and to forward this data to and from a CDPD radio 129. While severely limited in bandwidth, such a CDPD pathway provides a mechanism for transmission or reception of still images, low-bitrate audio, or other low-bandwidth signals. Through this Communications slice card 117, a user equipped with a CDPD device may thus gain access to resources on extended network 122 via the multi-protocol switch 110. Note that Communications slice card 117 may be configured for other communications media, such as the depicted interfaces to an INMARSAT radio 130 or Cellular radio 131. These communications media provide greater bandwidth than CDPD, thus users enjoy greater access to various network resources. Note that the actual radios themselves may be incorporated into a physical format directly compatible with multi-protocol switch 110 and backplane 111. Thus, an audio-only radio 118 may be incorporated into the multi-protocol switch in the form of a plug-in card. Alternatively, a CDPD radio card 119 or Cellular Radio card 120 may be incorporated directly into the multi-protocol switch 110.

An additional feature and function of the multi-protocol switch 110 allows data to be interchanged between media card slots, in addition to the basic function of routing data to and from extended network 122. Thus, visual or audio data, or indeed other data types, may be exchanged between a variety of otherwise incompatible device types. Thus, video received from camera 124, for example, may be forwarded via INMARSAT pathway 130 or Cellular pathway 131. Such data transactions are, of course, subject to bandwidth limitations imposed by the lowest-bandwidth communications link in the selected path. Thus, an established communications pathway between, for example, INMARSAT interface 130 and CDPD interface 129 would be subject to the 9.2 kbps limitation of the CDPD media.

Using the invention described in the previous section, multi-protocol switch 110 receives from camera 123, for example, several different versions of a given video image or motion sequence. Multi-protocol switch 110 may, therefore, selectively forward a version of said video image which satisfy the bandwidth constraints of any particular path. For example, when a user connects to multi-protocol switch 110 via INMARSAT interface 130 and requests camera video, multi-protocol switch 110 intelligently selects which version of camera 123's video is of sufficiently low bandwidth to operate via the INMARSAT pathway. The switch then proceeds to forward only that version of the compressed digital video stream via the INMARSAT. Conversely, when a user connects to multi-protocol switch 110 via CDPD interface 129, the multi-protocol switch 110 may select a different version of 123's compressed digital data stream, said version again satisfying the bandwidth limitation of the media in use, in this case CDPD radio.

In general, multi-protocol switch 110, using the previously-described invention (wherein cameras simultaneously produce several versions of a video stream with different bandwidths), provides a means for interoperation between various devices using different communications bandwidths, topologies, and protocols.

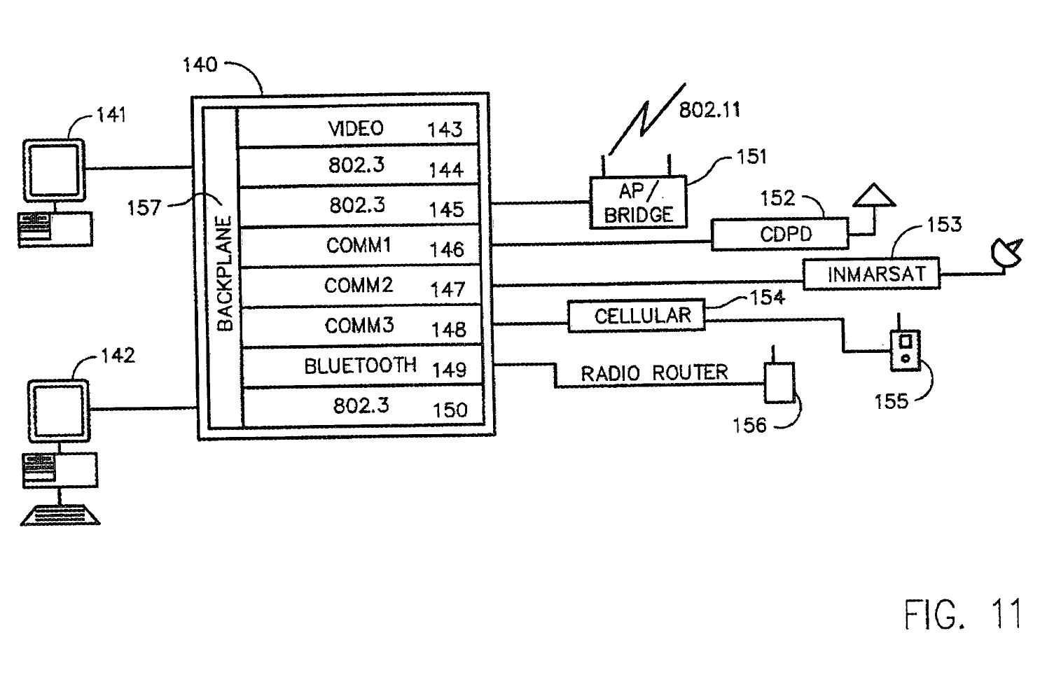

FIG. 11 depicts an elaboration of the multi-protocol switch, and interoperation between different media types. Multi-protocol switch 140 contains backplane bus 157, as before. In addition, the multi-protocol switch 140 contains interfaces for analog video 143, IEEE 802.3 Ethernet 144, 145 and 150, various communications pathways 146, 147, and 148, and a Bluetooth wireless LAN interface 149. Monitoring stations 141 and 142 are connected to a pair of Ethernet ports on multi-protocol switch 140. Using the previously described invention, the switch intelligently supports interoperation between these different media types, and allows users at monitoring stations 141 and 142 to receive compressed digital video streams or images via a plurality of different media. As before, said received transmissions are bandwidth-limited by the particular media in use. In FIG. 11, the various compressed video streams or images are produced by remote cameras (not shown), and conveyed to the multi-protocol switch 140 via the various media depicted. Multi-protocol switch 140 forwards these streams or images to monitoring stations 141 or 142 upon request. Alternatively, multi-protocol switch 140 may forward a compressed video stream or image from one low-bandwidth port to another, again subject to the limitation of the lowest-bandwidth media in the selected path. Additionally, multi-protocol switch 140, in communication with the various remote cameras (not shown), is able to command said remote cameras to forward a selected version of their compressed stream or images, subject to the bandwidth limitation known by switch 140. So, for example, if a monitor station connected via 802.11 bridge 151 requests video or images from a camera connected via INMARSAT link 153, the multi-protocol switch 140 requests a version of said remote camera's video of up to 128 kbps in bandwidth. However, if the same user, again using the 802.11 communications pathway, requests a video stream or image from a camera connected via CDPD pathway 152, the multi-protocol switch 140 will request a copy of the remote camera's video, this time with a bandwidth limitation of 9.2 kbps or less. In general, multi-protocol switch 140 intelligently requests video or image data from the various remote cameras, based on the particular bandwidth limitations known by the switch.

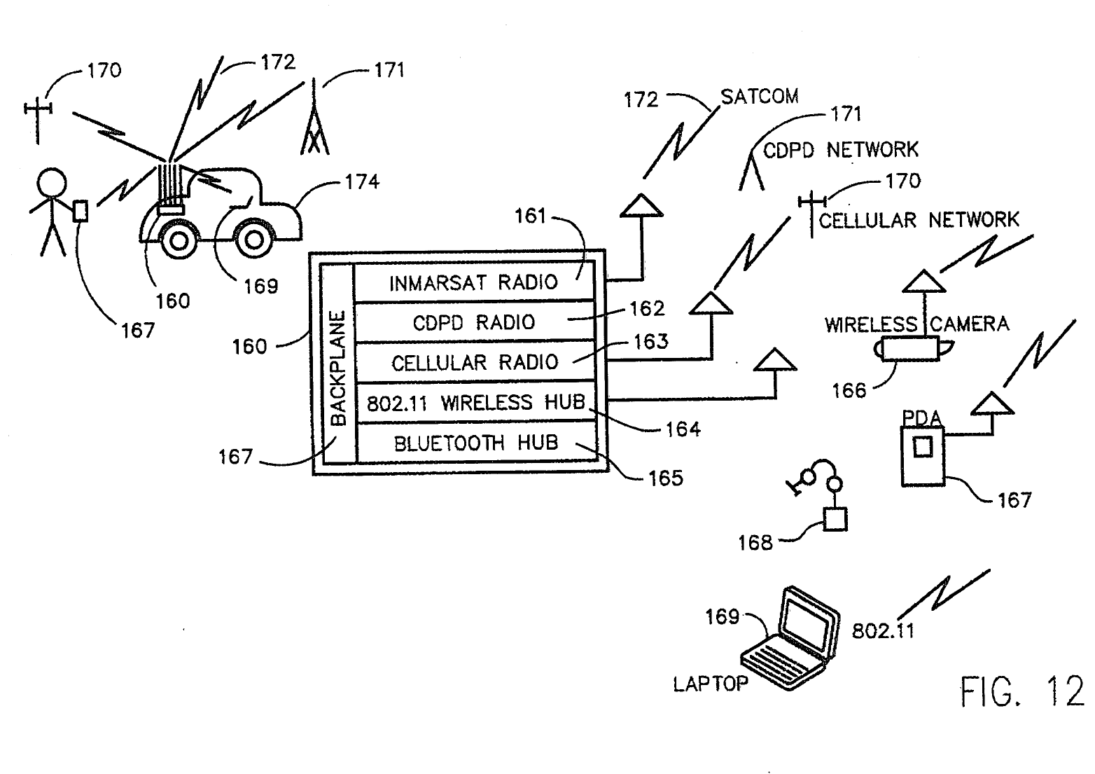

FIG. 12 depicts a mobile application of the multi-protocol switch. In this case, multi-protocol switch 160 is installed in a vehicle 174, to be used for mobile security or emergency response. Multi-protocol switch is again equipped with a variety of communications interfaces, including for example an INMARSAT radio 161 which connects to satellite link 172, CDPD radio 162 which connects to CDPD network 171, Cellular radio 163 which connects to cellular network 170, IEEE 802.11 wireless hub 164, and Bluetooth hub 165 among others. In this mobile application, vehicle 174 is equipped with one or more wireless cameras 166. These cameras previously disclosed, produce compressed video and image data streams, and forward them to multi-protocol switch 160 via the 802.11 wireless network hub 164. The cameras imagery can subsequently networked over a variety of media. A local user, for example, may select and view the cameras imagery via an 802-11-equipped laptop computer 169, or on a local PDA 167 using the Bluetooth hub 165. Either of these wireless networks posses sufficiently robust bandwidth, as to allow all the various video and image formats produced by cameras 166 to reach the multi-protocol switch 160. Such imagery is then available for distribution over a variety of communications pathways such as the INMARSAT link 172, Cellular network 170, or CDPD network 171 to name a few such examples.

Dynamic Selection and Mapping of Multiple Video Compression Resources Based on User Demand and Available Network Bandwidth

Referring again to FIG. 1, the previously-disclosed video surveillance network contains a plurality of video cameras, wherein each such camera contains a video digitizer 2 and more than one video compression device 3. In one embodiment, video compression is accomplished through the use of a trio of multi-protocol compression chips such as the Cheertek W99200F.

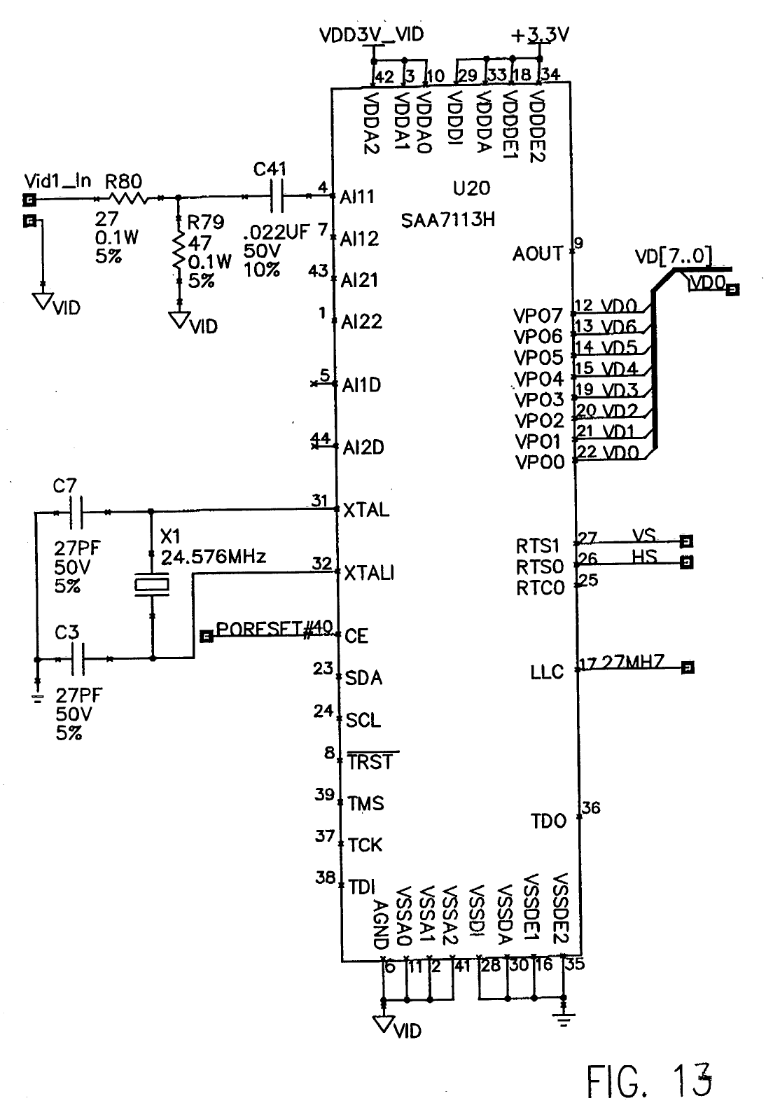

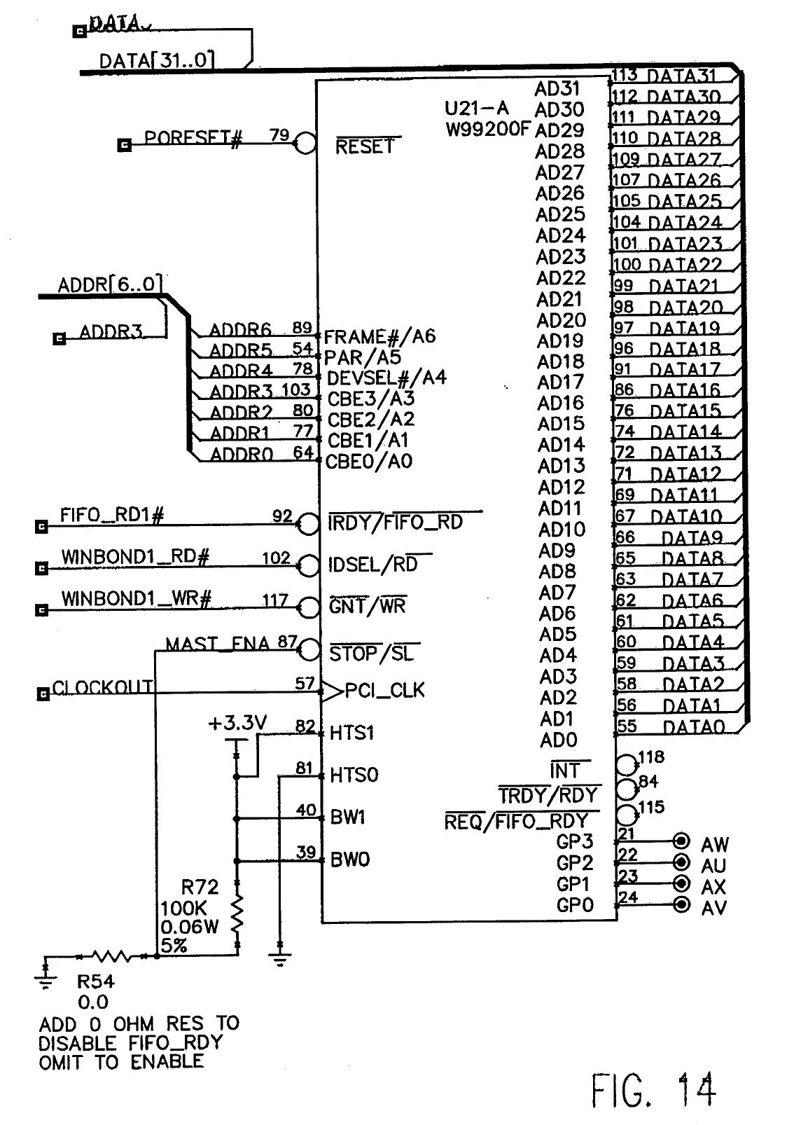

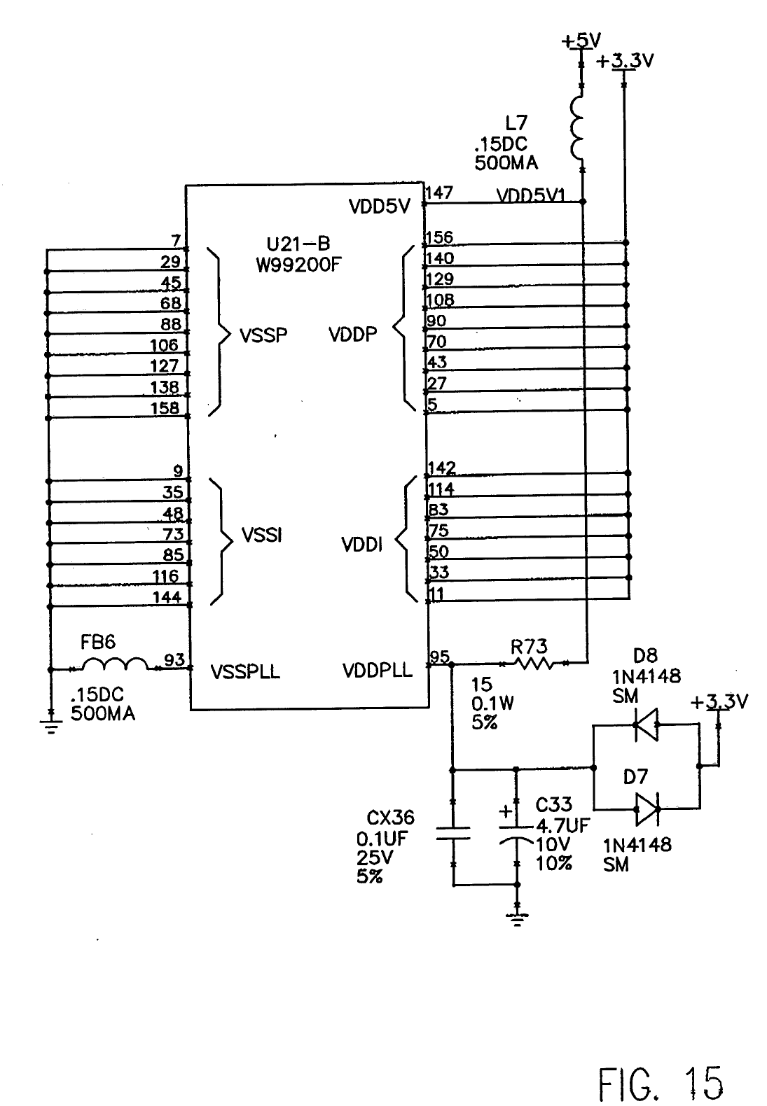

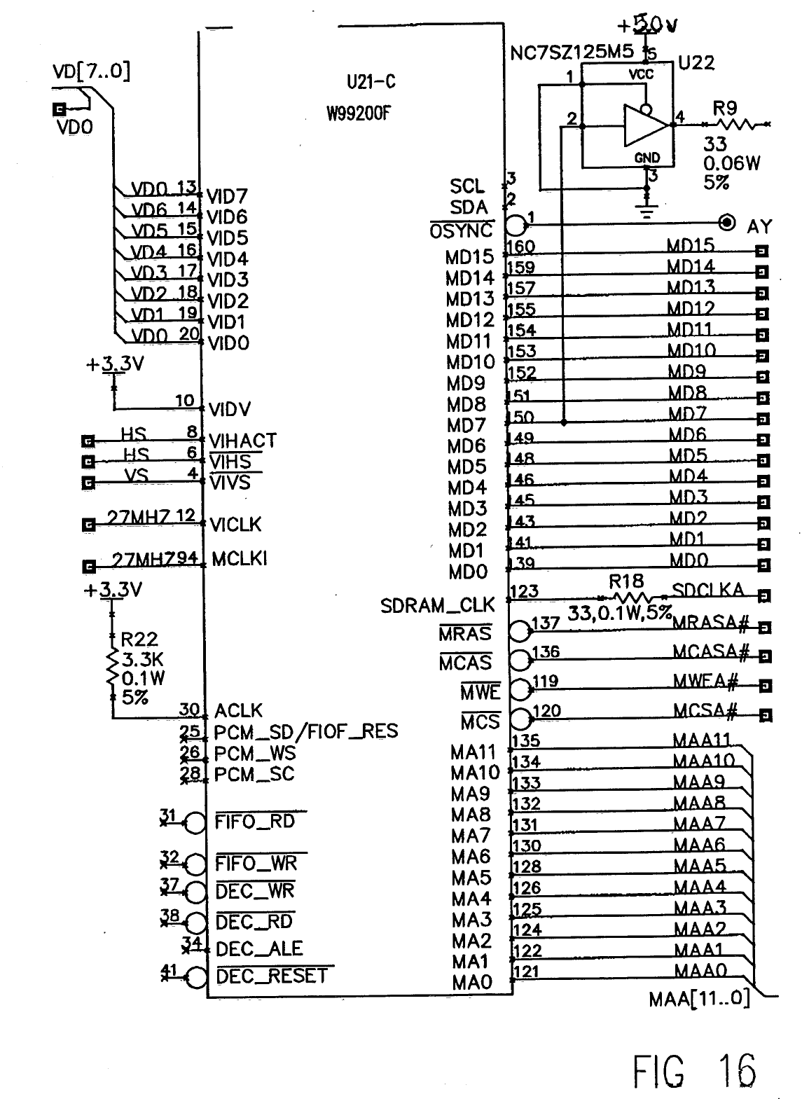

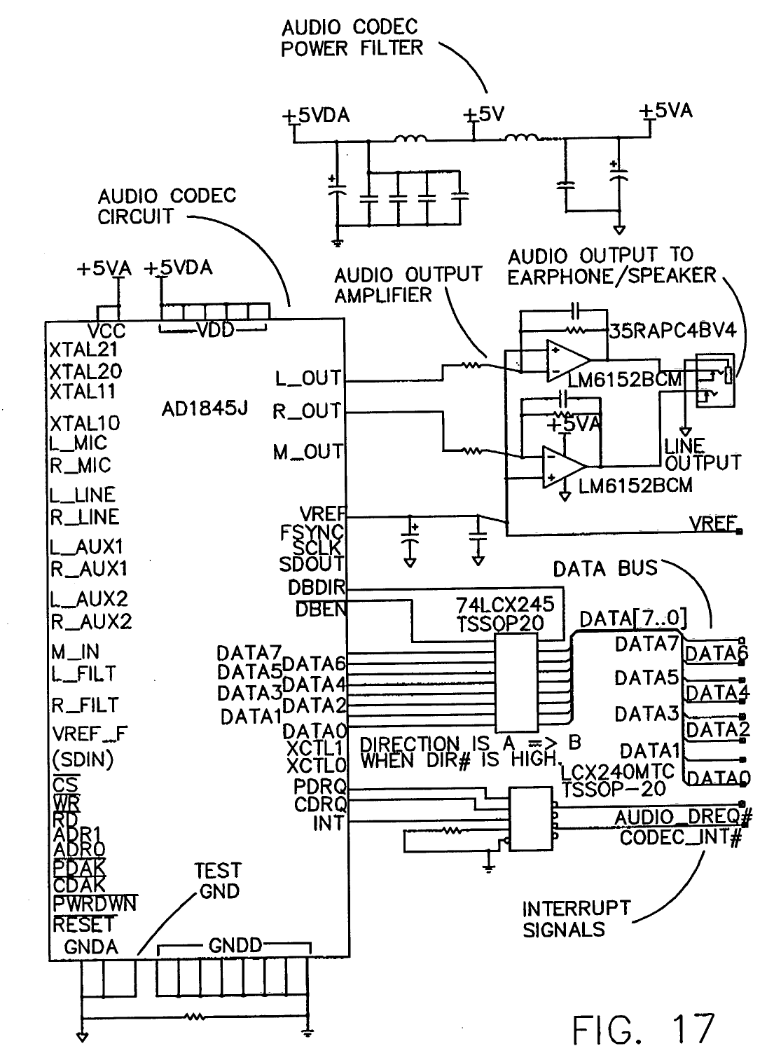

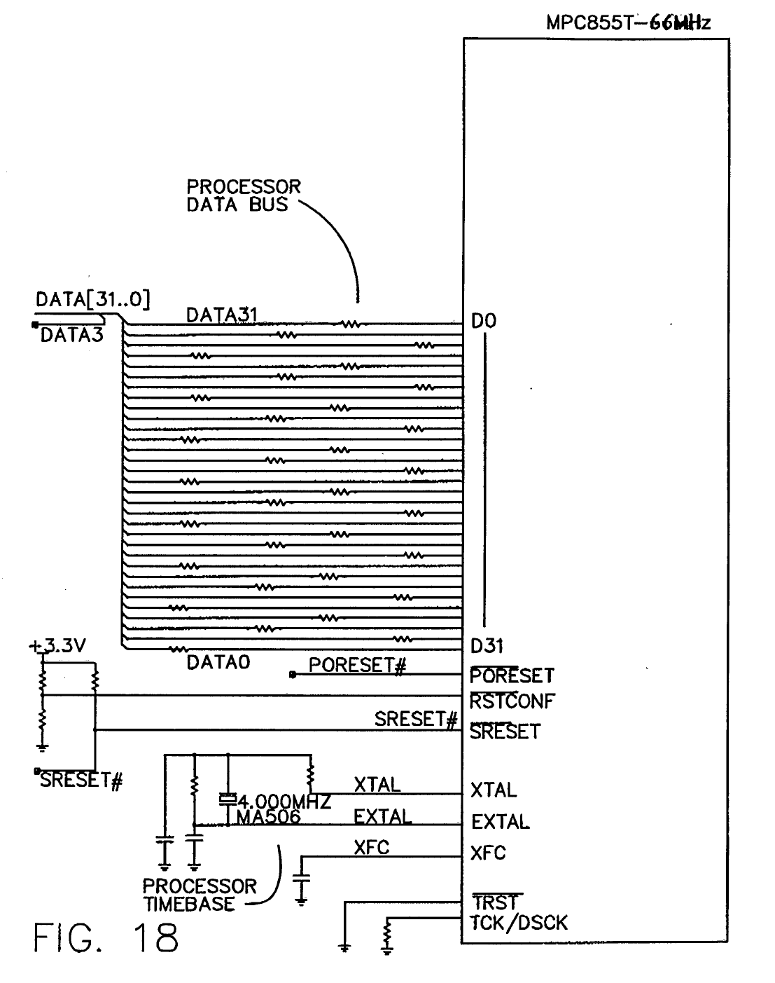

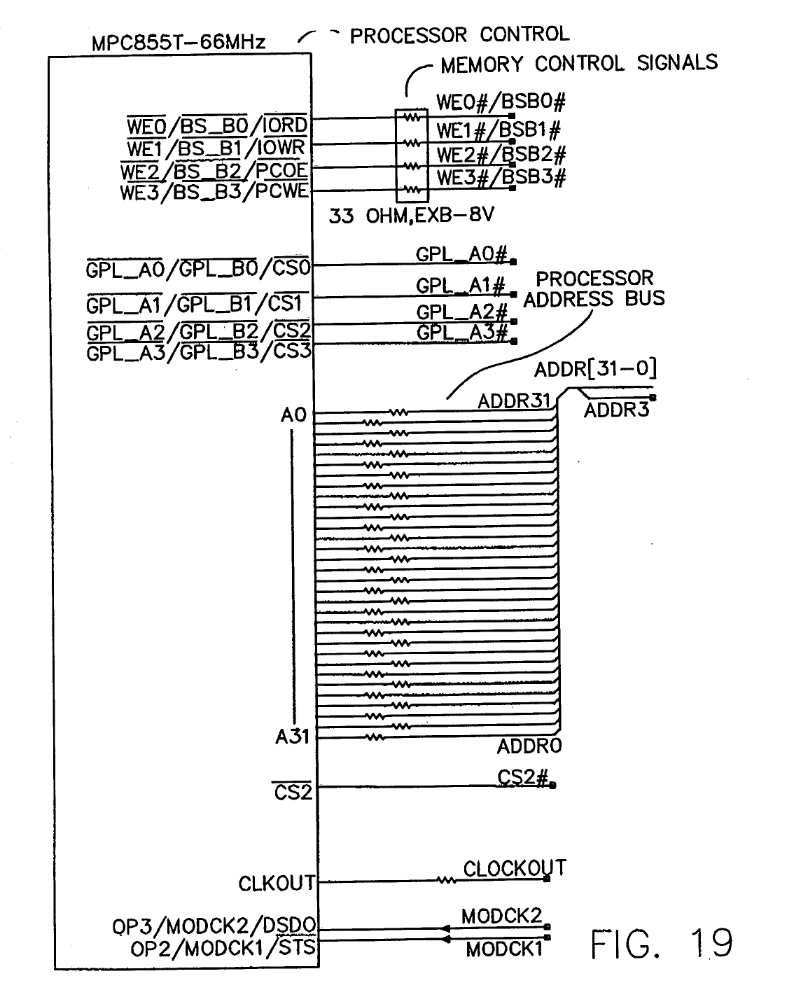

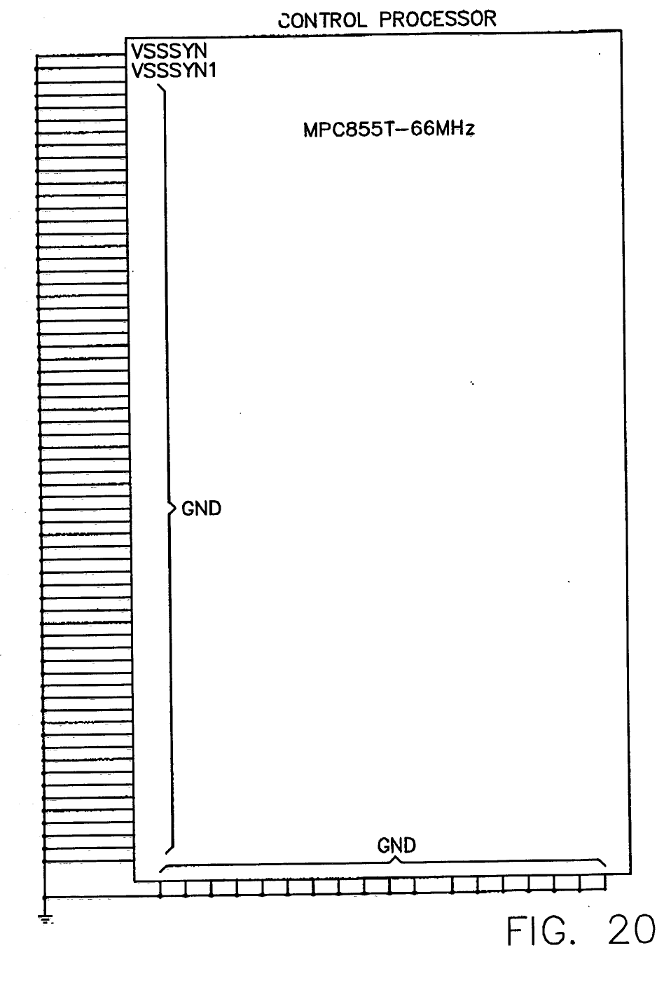

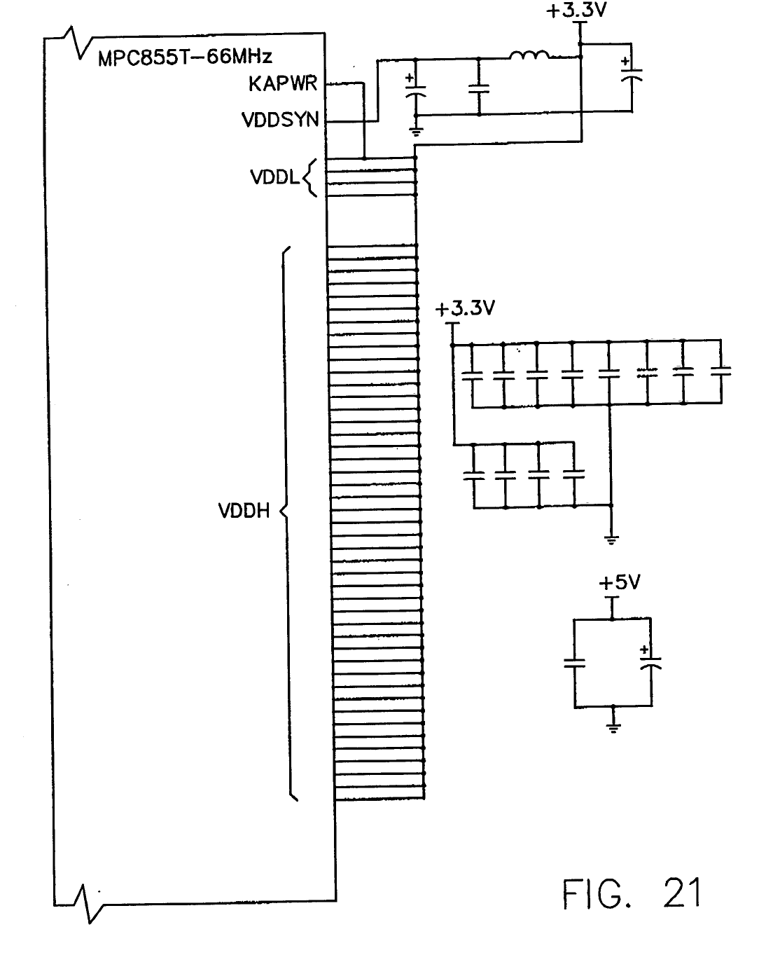

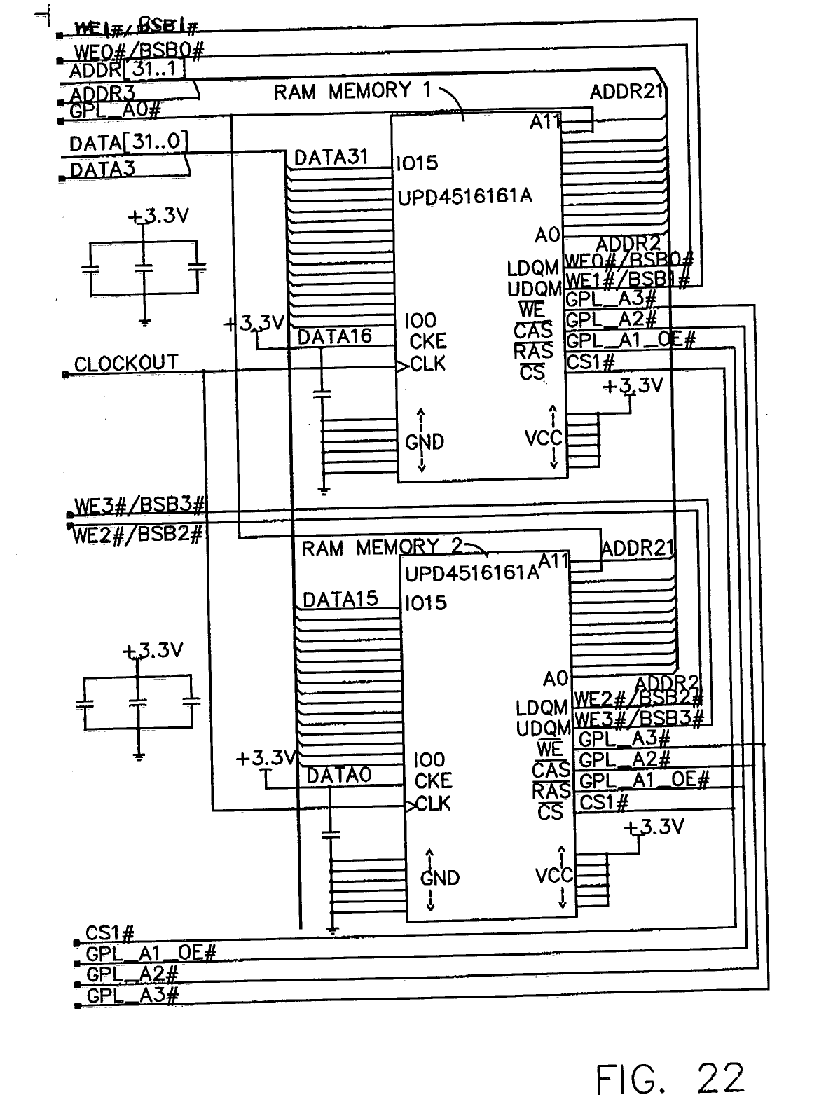

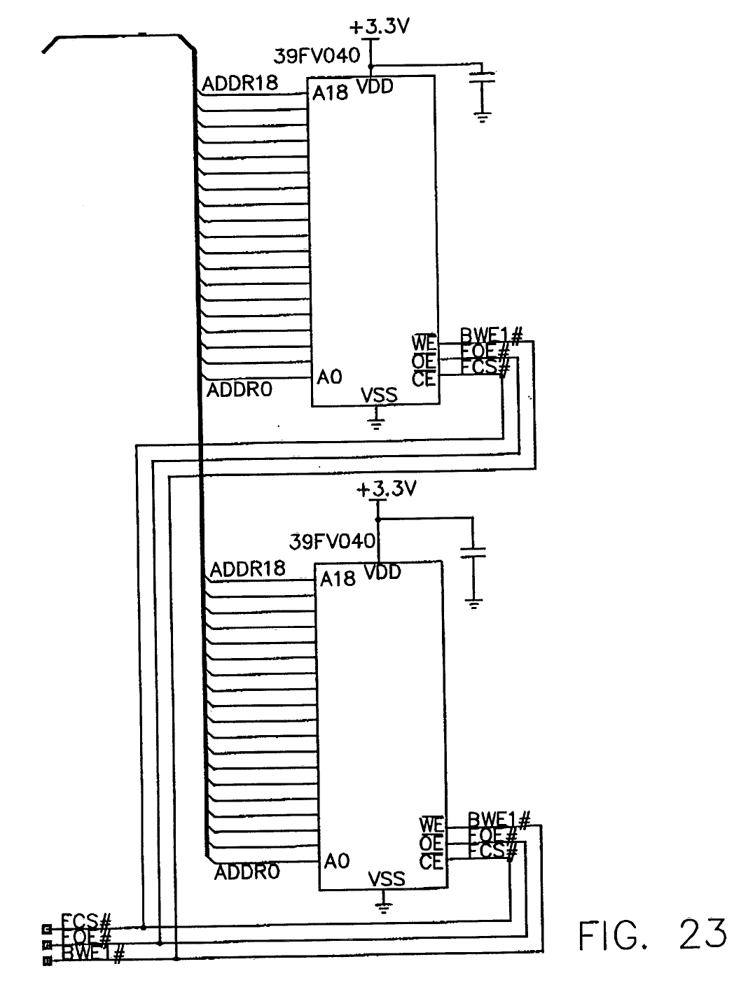

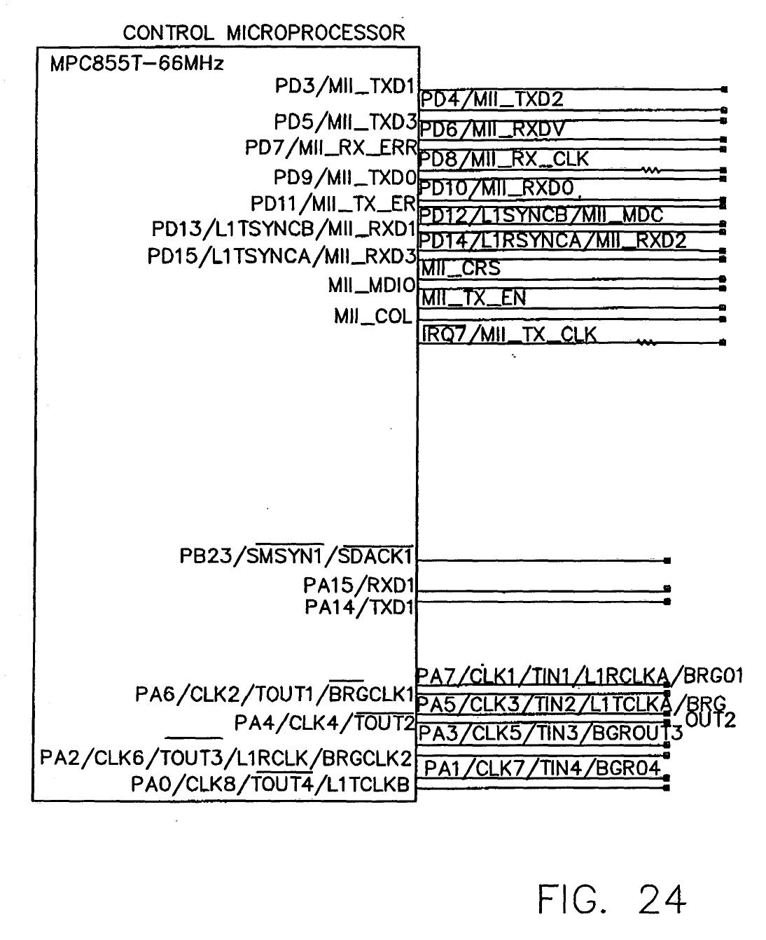

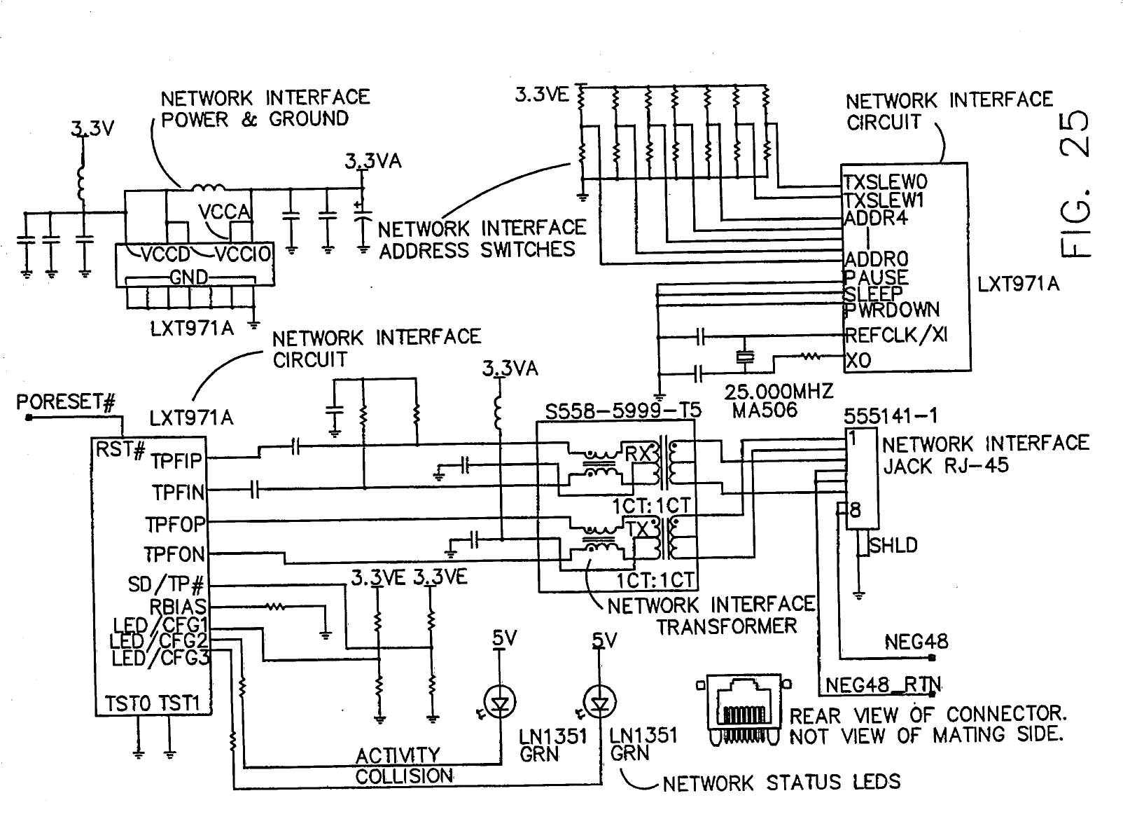

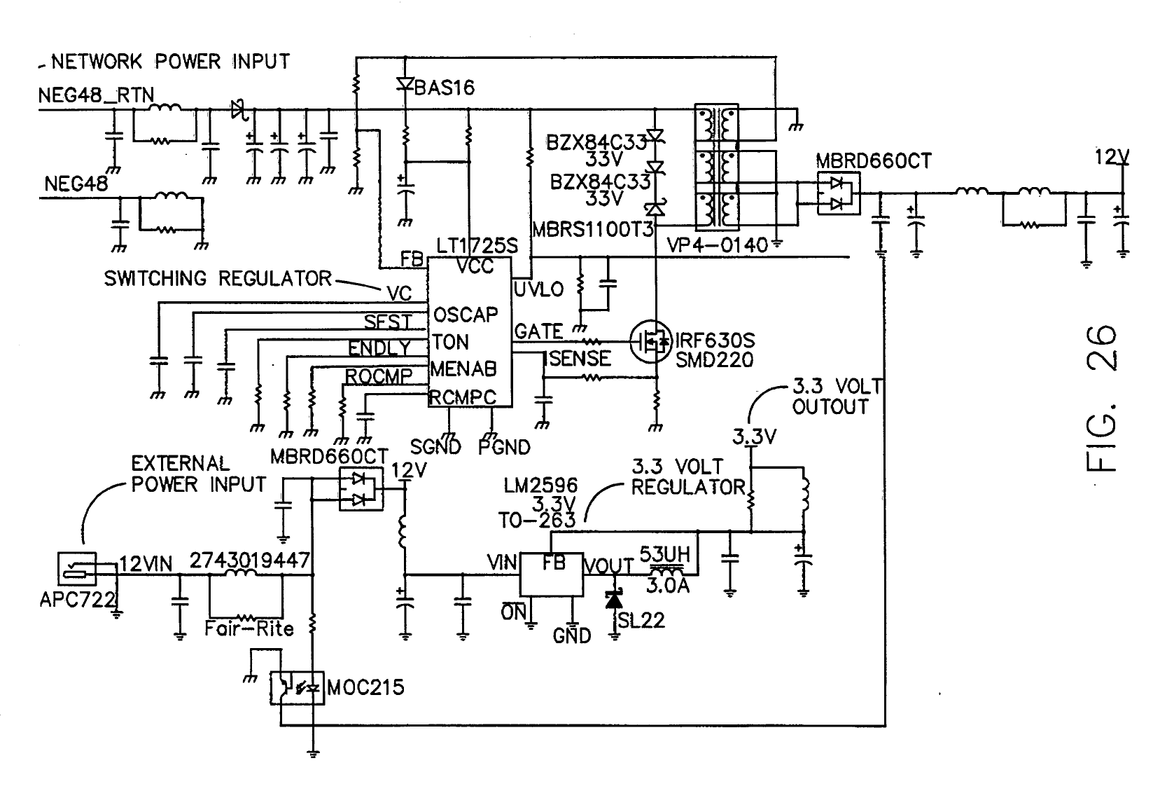

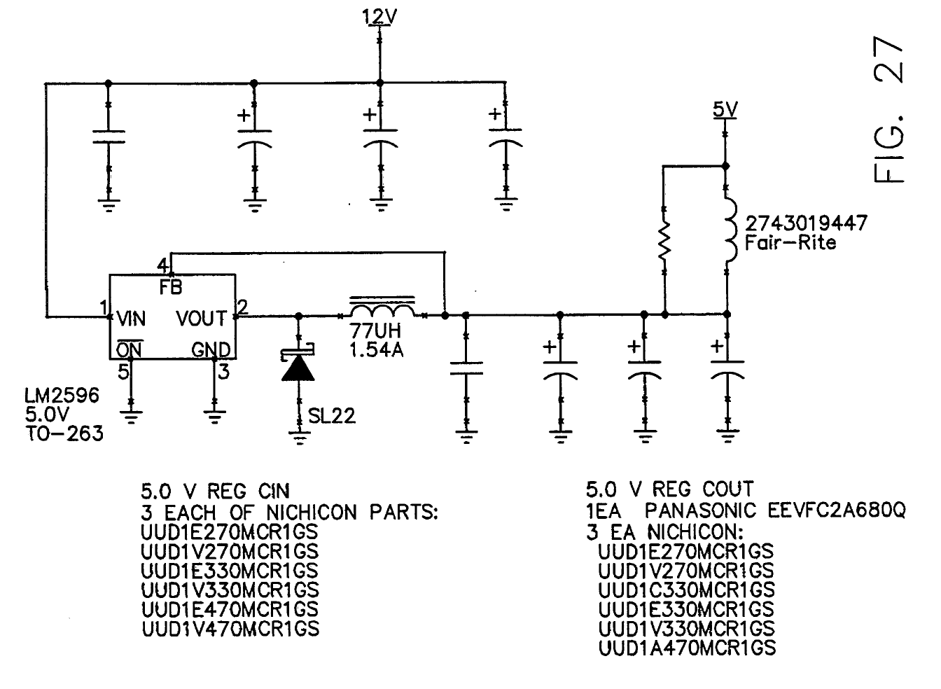

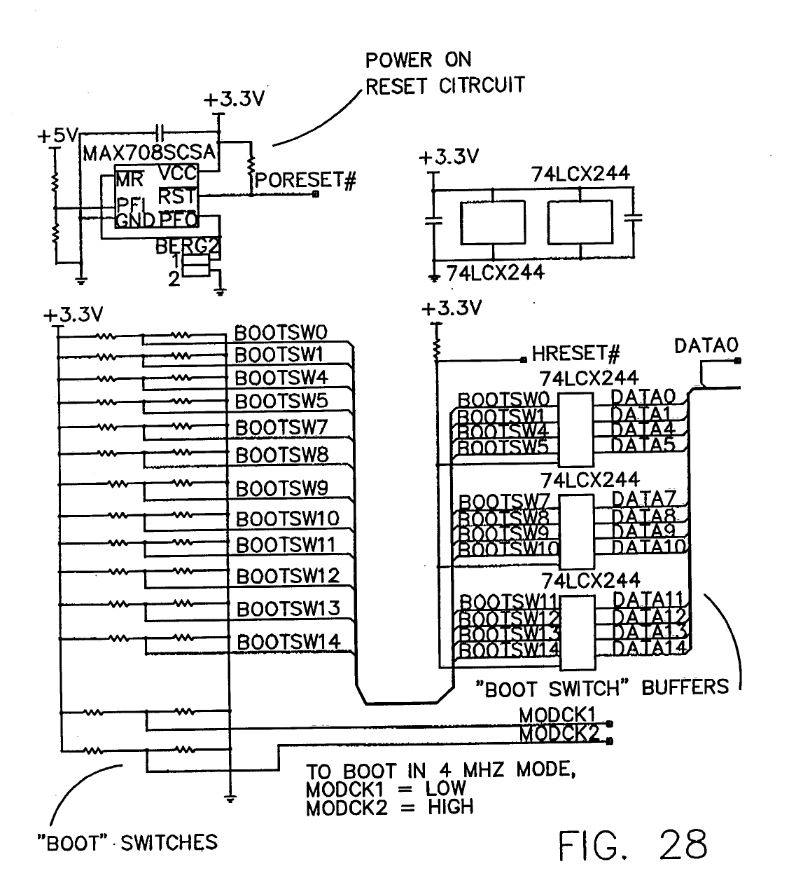

This implementation is shown in greater detail in FIGS. 13 through 28, which depict the overall electrical schematic of the preferred embodiment. FIG. 13 shows the analog video front-end/digitizer. FIGS. 14,15, and 16 show an instance of the actual video compression engine, a commercially-produced ASIC which can be programmed to produce MPEG, JPEG, or motion JPEG output stream formats under software control. As previously stated, three such devices are used in the implementation, even though only one is depicted. FIG. 17 shows the analog audio digitizer. FIGS. 18 through 21 depict the system processor, while FIGS. 22 and 23 depict the processor's RAM and Flash ROM respectively. FIG. 24 depicts the processor's Me'ia Independent Interface (MII) connection arrangement to the Ethernet Physical-Layer Interface (PHY). FIG. 25 depicts the PHY itself. FIGS. 26 and 27 depict the system's power supply, operable to receive operating power from the Ethernet cabling plant. Finally, FIG. 28 depicts the processor's boot-time option programming arrangement.

The video compressor devices accept a digitized composite video signal, and is configured via software to compress the signal into an MPEG stream, a JPEG still-frame image, or an M-JPEG sequence of still images at selectable frame rates. As disclosed in previous applications, embedded firmware in the camera configures one chip to compress the video into a SIF-resolution, 30 frames-per-second MPEG stream at approximately 1 Mbps. Another chip is configured by software to compress the video into a QSIF-resolution, 30 framer-per-second MPEG stream of approximately 128 kbps. Finally, the their chip is configured by software to compress the video into a high-resolution (720×480 pixel) still-frame image of between 50 to 100 kbytes. The third chip is additionally used to detect motion within the camera's filed of view, by detecting and evaluating differences between selected captured images. Having the cameras imagery available on a network at a variety of resolutions and bitrates improves both the availability of the video to remote monitoring sites, and the resolution and quality of images stored locally in a networked archive.

The present invention improves the flexibility of the camera, by providing a greater degree of choice of image resolution, frame rate, overall quality, and bitrate. As described earlier in this document, the camera may dedicate one of the compression chips to the production of a sequence of still-frame images of varying bitrate. Thus, remote monitoring stations over limited-bandwidth communications paths are able to select a version of the camera's imagery compatible with the bandwidth limitations. Simultaneously, monitoring stations enjoying wider-bandwidth communications paths may select a higher-bitrate version of the same imagery, and enjoy greater image resolution or quality.

In the present invention, all of the video compression chips are configured by software to produce a video format compatible with the communications capacity of current users. In other words, instead of leaving two of the compression chips dedicated to a particular type of video compression as before, the software instead determines what type of compression is currently required by the various monitoring stations, based on their communications bandwidth. Thus, a compression chip may be dynamically re-configured, by software, to stop sending high-bitrate MPEG motion video if there are no current viewers thereof, and may instead be configured by software to compress the video into a Motion-JPEG format, as appropriate to a (new) monitoring station with limited bandwidth.

This dynamic mapping of available compression resources need not be limited to video compression alone. Audio, as associated with a particular camera, may also be digitized, compressed, and transferred via network to a monitoring station. The audio may be compressed to different degrees, resulting in different audio bit-rates. As with video, this degree of compression is under the dynamic control of the camera's application software. Monitoring stations with limited-bandwidth communications paths may required a lower-bitrate replica of the captured audio, while monitoring stations enjoying more robust communications paths preferably receive audio with a higher bitrate, and accordingly higher perceived quality.

As described heretofore, video compression is accomplished with dedicated hardware devices. In an alternative and preferred embodiment, video compression and audio compression is performed instead by a fast, dedicated Digital Signal Processor (DSP). Modern DSP devices, such as the Texas Instruments TMS320DM642, posses sufficient signal processing capacity and speed to execute multiple simultaneous video and audio compression algorithms, in software. This approach is advantageous, in that the DSP resource may be more easily re-configured to produce a wider variety of video (or audio) compression types. For example, the DSP compression resource may be re-configured from MPEG-1 compression to JPEG compression, simply by commanding the device to execute a different part of it's stored program, or indeed by re-loading the stored program. An additional advantage is that one such DSP resource, if sufficiently fast, may simultaneously produce more than one compressed stream. An additional advantage of this approach is it's extensibility. The DSP chip may be programmed to switch from MPEG-1 to MPEG-2, or even to other compression algorithms altogether such as Wavelet or motion-wavelet, or possible future compression algorithms.

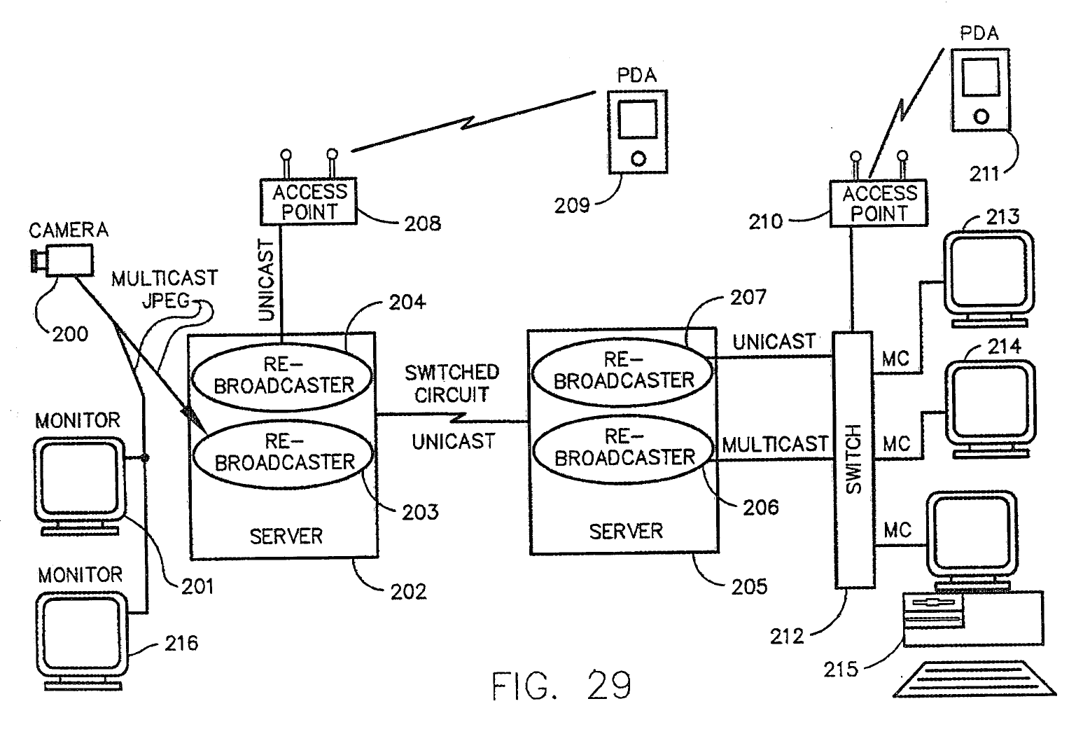

In an additional aspect of the invention, the still-frame sequence thus generated is transferred over an IP network, in the form of a Multicast stream. Use of the Multicast protocol allows more than one remote station to view the video or still-frame motion sequence simultaneously. In FIG. 29, for example, camera 200 produces a still-frame image sequence as previously described. The still-frame image sequence, transmitted as a multicast stream, may be received by several devices on the local network such as monitor terminals 201 and 216, as well as server 202. Similarly, in FIG. 29, the cameras still-frame video sequence is sent as a multicast stream from server 205 to network switch 212, which disseminates said multicast stream to several devices on that local network. Terminals 213 and 214, for example, may simultaneously receive and display the still-frame image sequence as generated by the camera. Other types of devices may additionally receive the still-frame image sequence, for other purposes. For example, image processing workstation 215 may receive the multicast stream, and perform some useful task on the received images such as facial recognition, motion detection, and the like.

IP networks lend themselves easily to multicast data streams. Other types of communications paths or networks do not. A circuit-switched network, such as an ISDN connection for example, do not lend itself easily to multicast traffic because the related and necessary IP protocols are not in use. Also, wireless LAN segments such as Access Points 208 and 210 in FIG. 29 and their associated wireless PDA's do not easily support Multicast traffic. Another aspect of the invention supports the transmission of these video or still-frame sequence streams by converting them from a multicast-protocol format to a unicast-protocol format prior to their transmission over an incompatible communications path. FIG. 29 again illustrates the concept. The still-frame image sequence from camera 200 arrives at network server 202 as a multicast stream. A software task inside the server, called a re-broadcaster, changes the data stream type from a multicast format to a unicast format. For example, re-broadcaster 203 produces a unicast output stream corresponding to the camera's multicast stream, and forwards said unicast stream through the circuit-switched path to the next server 205. Additionally, re-broadcaster 204 forwards the camera's multicast stream as a unicast stream to wireless access point 208, which thereupon forwards the unicast stream to wireless PDA 208. In either case, the unicast stream thus generated is able to traverse a communications pathway otherwise not compatible with multicast traffic.

While certain embodiments and features have been described in detail herein, it will be understood that the invention incorporates all of the enhancements and modifications within the scope and spirit of the following claims.

What is claimed is:

1. A method for sending files of varying resolution over a network depending upon the capacity of the network, comprising the steps of:
a. collecting raw data at a source;
b. defining files of said data;
c. selecting a specific network over which to transmit the files; 1
d. selecting a level of resolution based on the network;
e. converting the data to the selected resolution; and
f. transmitting the data over the selected network.

2. The method of claim 1, wherein the data file is an image file.

3. The method of claim 1, wherein the data file is an audio file.

4. The method of claim 1, further including the step of time stamping the file based on the time when the raw data was collected.

5. The method of claim 4, wherein a plurality of files are sent in succession and the time stamp assures that the data may be identified in chronological order based on time of collection.

6. A method for sending files of varying resolution to a remote receiver depending upon the capacity of the receiver, comprising the steps of:
a. collecting raw data at a source;
b. defining files of said data;
c. selecting a specific receiver to which to transmit the files; 1
d. selecting a level of resolution based on the receiver;
e. converting the data to the selected resolution; and
f. transmitting the data to the receiver.

7. The method of claim 6, wherein the data file is an image file.

8. The method of claim 6, wherein the data file is an audio file.

9. The method of claim 6, further including the step of time stamping the file based on the time when the raw data was collected.

10. The method of claim 9, wherein a plurality of files are sent in succession and the time stamp assures that the data may be identified in chronological order based on time of collection.

11. A method for sending files of in one of a plurality of protocols over a network depending upon the protocol of a remote receiver, comprising the steps of:
a. collecting raw data at a source;
b. defining files of said data;
c. selecting a specific receiver for receiving the files;
d. selecting a protocol based on the receiver;
e. converting the data to the selected protocol; and
f. transmitting the data over the selected network to the receiver.

12. The method of claim 11, wherein the data file is an image file.

13. The method of claim 11, wherein the data file is an audio file.

14. The method of claim 11, further including the step of time stamping the file based on the time when the raw data was collected.

15. The method of claim 14, wherein a plurality of files are sent in succession and the time stamp assures that the data may be identified in chronological order based on time of collection.

16. The method of claim 11, further including the step of selecting a level of resolution based on the network

17. The method of claim 11, further including the step of selecting a level of resolution based on the receiver.
